(19) United States
(12) Patent Application Publication
(10) Pub. No.: US 2026/0347008 A1
(43) Pub. Date: Nov. 5, 2026

(54) SYSTEMS AND METHODS FOR CAPTURING SPACE OBJECTS

(71) Applicant: Trans Astronautica Corporation, Lake View Terrace, CA (US)

(72) Inventors: Joel C. Sercel, Lake View Terrace, CA (US); Hayden Andrew Burgoyne, Glendale, CA (US); Kieana Fana, North Hollywood, CA (US); James G. Small, Sonoita, AZ (US); Edwin Wellington Froelich, Burbank, CA (US); Caleb Ean Kracke-Bock, Burbank, CA (US); Philip J. Wahl, San Luis Obispo, CA (US); Thibaud Talon, Los Angeles, CA (US)

(21) Appl. No.: 19/485,826

(22) PCT Filed: May 22, 2024
(86) PCT No.: PCT/US2024/030655

§ 371 Date: Nov. 19, 2025

Related U.S. Application Data
(60) Provisional application No. 63/503,938, filed on May 23, 2023.

(51) Int. Cl. B64G 1/10; B64G 1/22; B64G 1/54; B64G 4/00; E21C 51/00

(52) U.S. Cl. CPC B64G 1/1081; B64G 1/2222; B64G 1/2227; B64G 1/54; B64G 4/00; E21C 51/00

(57) ABSTRACT

Systems and methods for capturing space objects are provided. In one aspect, a capture bag for capturing space debris includes a main bag configured to open to allow a plurality of target objects to enter the main bag and a containment system configured to separately contain the plurality of target objects. Various enclosures and extension structures are described.

### INCORPORATION BY REFERENCE TO ANY PRIORITY APPLICATIONS

This application is based upon and claims the benefit of priority from U.S. Provisional Patent Application No. 63/503,938 filed on May 24, 2023. Moreover, any and all applications for which a foreign or domestic priority claim is identified in the Application Data Sheet as filed with the present application are hereby incorporated by reference under 37 CFR 1.57. The entire contents of each of the above-listed items is hereby incorporated into this document by reference and made a part of this specification for all purposes, for all that each contains.

### BACKGROUND

### Field

This application generally relates to systems and methods for capturing objects in space.

### SUMMARY

The launch of satellites and other objects into space has led to objects and other types of undesirable debris accumulating in Earth's orbit. As the amount of debris increases, it can potentially collide with satellites or newly launched spacecraft. Collisions with space debris are a potential source of failure for space missions, and thus, it is desirable to be able to capture space objects and/or debris to reduce the chance of collisions.

One aspect of this disclosure is a capture bag for capturing space debris, including: a main bag configured to open to allow a plurality of target objects to enter the main bag; and a containment system configured to separately contain the plurality of target objects.

In some aspects, the techniques described herein relate to a capture bag, wherein the containment system includes: a plurality of flexible nets arranged in layers within the main bag, wherein each of the flexible nets is configured to contain one or more of the plurality of target objects.

In some aspects, the techniques described herein relate to a capture bag, further including: at least one cable coupled to the flexible nets; and a motor configured to separately reel in each of the flexible nets using the at least one cable, each of the flexible nets configured to contract onto the one or more of the plurality of target objects when reeled in via the at least one cable.

In some aspects, the techniques described herein relate to a capture bag, further including: at least one elastic cable coupled to the flexible nets, the at least one elastic cable configured to separately reel in each of the flexible nets, each of the flexible nets configured to contract onto the one or more of the plurality of target objects when reeled in via the at least one elastic cable.

In some aspects, the techniques described herein relate to a capture bag, wherein the containment system includes: a plurality of flexible bags arranged in layers within the main bag, wherein each of the flexible bags is configured to contain one or more of the plurality of target objects.

In some aspects, the techniques described herein relate to a capture bag, further including: at least one cable coupled to the flexible bags; and a motor configured to separately reel in each of the flexible bags using the at least one cable, each of the flexible bags configured to contract onto the one or more of the plurality of target objects when reeled in via the at least one cable.

In some aspects, the techniques described herein relate to a capture bag, wherein each of the flexible bags is configured to contain leaking liquids and/or fragments of the plurality of target objects.

In some aspects, the techniques described herein relate to a capture bag, further including: one or more nozzles configured to separately spray foam onto each of the plurality of target objects, the foam configured to separately stick to each of the plurality of target objects and expand to conform to shapes of the plurality of target objects.

In some aspects, the techniques described herein relate to a capture bag, further including: a plurality of deployment struts configured to expand to support the main bag; and an inflation system configured to inflate the plurality of deployment struts.

In some aspects, the techniques described herein relate to a capture bag, further including a trash compactor configured to separately compact each of the plurality of target objects.

In some aspects, the techniques described herein relate to a capture bag, wherein the main bag is formed of a material selected to act as a shield for electromagnetic radiation to prevent outside radiation or signals from reaching the target objects and/or to prevent radiation from the target objects from interfering with outside activities.

In some aspects, the techniques described herein relate to a capture bag, wherein the shield is configured to block one or more of the following fields: electrostatic, radio frequency and microwave, infrared, visible, and/or ultraviolet radiations.

In some aspects, the techniques described herein relate to a capture bag wherein the main bag has an interior layer configured to absorb radiation emitted from the target objects.

In some aspects, the techniques described herein relate to a capture bag, wherein: the main bag includes electrically conductive current loops have been incorporated into the main bag, the electrically conductive current loops are configured to generate a solenoidal magnetic field configured to act against external magnetic fields when supplied with electrical current to apply mechanical torques to a spacecraft coupled to the capture bag.

In some aspects, the techniques described herein relate to a capture bag, further including one or more flexible pressure-tight deployment tubes configured to be inflated to unfold the main bag from a stowed configuration.

In some aspects, the techniques described herein relate to a capture bag, wherein the main bag has a deployed shape determined by controlled inflation of the one or more flexible pressure-tight deployment tubes, the one or more flexible pressure-tight deployment tubes including a plurality ribs and a plurality of struts that are fixed to the capture bag and are attached to the main bag at several attachment points.

In some aspects, the techniques described herein relate to a capture bag, wherein the deployed shape of the capture bag is configured to be changed and/or adjusted to close and capture the target objects by selectively inflating the plurality ribs and the plurality of struts.

In some aspects, the techniques described herein relate to a capture bag, wherein the main bag is configured to be unfolded from a stowed configuration by releasing a plurality of pretensioned tape springs.

In some aspects, the techniques described herein relate to a capture bag, wherein the main bag and one or more flexible deployment tubes are configured to be z-folded to a stowed configuration.

In some aspects, the techniques described herein relate to a capture bag, wherein each of the flexible deployment tubes includes an internal porous tube having a computer-controlled gas discharge port configured to vent trapped gasses into space before the capture bag is released for controlled inflation.

In some aspects, the techniques described herein relate to a capture bag, wherein the flexible deployment tubes are constructed from a gas-tight membrane that has been bonded to an internal fabric liner including loosely meshed fibers.

In some aspects, the techniques described herein relate to a capture bag, wherein the main bag includes a first main bag and a second main bag, the second main bag configured to be closed and sealed independently of the first main bag.

In some aspects, the techniques described herein relate to a capture bag, wherein: the second main bag is configured to capture, enclose, and hermetically seal a contaminated space object, and the first main bag is configured to enclose the second main bag to prevent contamination of an outer surface of the second main bag.

In some aspects, the techniques described herein relate to a method of capturing space debris, including: opening a main bag of a capture bag; capturing a first target through the opening of the main bag; sealing the main bag and containing the first target; opening the main bag; capturing a second target through the opening of the main bag; and sealing the main bag and containing the first target.

In some aspects, the techniques described herein relate to a method, wherein: containing the first target includes containing the first target in a first flexible net; and containing the second target includes containing the second target in a second flexible net, the first and second flexible nets arranged in layers within the main bag.

In some aspects, the techniques described herein relate to a method, further including: separately reeling in the first and second flexible nets using a motor and at least one cable such that the first and second flexible nets respectively contract onto the first and second targets.

In some aspects, the techniques described herein relate to a method, further including: separately reeling in the first and second flexible nets using an elastic cable such that the first and second flexible nets respectively contract onto the first and second targets.

In some aspects, the techniques described herein relate to a method, wherein: containing the first target includes containing the first target in a first flexible bag; and containing the second target includes containing the second target in a second flexible bag, the first and second flexible bag arranged in layers within the main bag.

In some aspects, the techniques described herein relate to a method, further including: separately reeling in the first and second flexible bags using at least one cable such that the first and second flexible bags respectively contract onto the first and second targets.

In some aspects, the techniques described herein relate to a method, wherein each of the flexible bags is configured to contain leaking liquids and/or fragments of the first and second targets.

In some aspects, the techniques described herein relate to a method, further including: separately spraying, using one or more nozzles, foam onto each of the first and second targets, the foam configured to separately stick to each of the first and second targets and expand to conform to shapes of the first and second targets.

In some aspects, the techniques described herein relate to a method, further including: expanding a plurality of deployment struts to support the main bag; and inflate the plurality of deployment struts using an inflation system.

In some aspects, the techniques described herein relate to a method, further including: separately compacting each of the first and second targets using a trash compactor.

In some aspects, the techniques described herein relate to a system for capture of space objects, the system including: a proximity engine configured to locate the system within an operable distance of space debris; and a deployable structure configured to at least partially enclose the space debris, the deployable structure including: a surrounding material configured to at least partially enclose the space debris, the material having sufficient flexibility and resilience to reduce rotational energy and resist ripping; and an extension device configured to move the surrounding material through the operable distance such that the surrounding material at least partially encloses and thereby captures the space debris.

In some aspects, the techniques described herein relate to a system, wherein the surrounding material includes a mylar capture bag.

In some aspects, the techniques described herein relate to a system, wherein the surrounding material includes at least one net.

In some aspects, the techniques described herein relate to a system, wherein the surrounding material includes a foam material.

In some aspects, the techniques described herein relate to a system, wherein the surrounding material includes an outer capture bag and at least two internal surrounding structures.

In some aspects, the techniques described herein relate to a system, wherein the at least two internal surrounding structures include at least one resilient net configured to retain debris as the outer capture bag is re-opened to capture additional debris.

In some aspects, the techniques described herein relate to a system, wherein the extension device includes flexural inflatable struts configured to open the surrounding material.

In some aspects, the techniques described herein relate to a system, further including a robotic zipper configured to seal the surrounding material.

In some aspects, the techniques described herein relate to a system, further including a cable system configured to retract and retain the surrounding material and space debris.

In some aspects, the techniques described herein relate to a system, further including at least one proximity operation sensor.

In some aspects, the techniques described herein relate to a system, wherein the proximity engine includes a robotic arm end-effector.

In some aspects, the techniques described herein relate to a system, further including stereo cameras positioned within the surrounding material.

In some aspects, the techniques described herein relate to a system, wherein the surrounding material includes a first sacrificial material configured to slow rotation and a second material configured for long-term capture.

In some aspects, the techniques described herein relate to a system, wherein the surrounding material further including at least one mechanical rotation device configured to manage changes of angular momentum.

In some aspects, the techniques described herein relate to a system, wherein the surrounding material includes a main bag formed of a material selected to act as a shield for electromagnetic radiation to prevent outside radiation or signals from reaching the target objects and/or to prevent radiation from the target objects from interfering with outside activities.

In some aspects, the techniques described herein relate to a system, wherein the shield is configured to block one or more of the following fields: electrostatic, radio frequency and microwave, infrared, visible, and/or ultraviolet radiations.

In some aspects, the techniques described herein relate to a system, wherein the main bag has an interior layer configured to absorb radiation emitted from the target objects.

In some aspects, the techniques described herein relate to a system, wherein the surrounding material includes a main bag configured to at least partially enclose the space debris, the main bag including electrically conductive current loops incorporated therein and configured to generate a solenoidal magnetic field configured to act against external magnetic fields when supplied with electrical current to apply mechanical torques to a spacecraft coupled to the capture bag.

In some aspects, the techniques described herein relate to a system, wherein the surrounding material includes a main bag configured to at least partially enclose the space debris, and the extension device includes one or more flexible pressure-tight deployment tubes configured to inflate and unfold the main bag from a stowed configuration.

In some aspects, the techniques described herein relate to a system, the main bag having a deployed shape determined by controlled inflation of the one or more flexible pressure-tight deployment tubes, the one or more flexible pressure-tight deployment tubes including a plurality of ribs and a plurality of struts that are fixed to the capture bag and are attached to the main bag at several attachment points.

In some aspects, the techniques described herein relate to a system, wherein the deployed shape of the capture bag is configured to be changed and/or adjusted to close and capture the target objects by selectively inflating the plurality ribs and/or struts.

In some aspects, the techniques described herein relate to a system, wherein the surrounding material includes a main bag configured to at least partially enclose the space debris and configured to be unfolded from a stowed configuration by releasing a plurality of extension devices including pretensioned tape springs.

In some aspects, the techniques described herein relate to a system, wherein the surrounding material includes a main bag configured to at least partially enclose the space debris and the main bag and one or more extension devices including flexible deployment tubes are configured to be z-folded to a stowed configuration.

In some aspects, the techniques described herein relate to a system, wherein each of the flexible deployment tubes includes an internal porous tube having a computer-controlled gas discharge port configured to vent trapped gasses into space before the capture bag is released for controlled inflation.

In some aspects, the techniques described herein relate to a system, wherein the flexible deployment tubes are constructed from a gas-tight membrane that has been bonded to an internal fabric liner including loosely meshed fibers.

In some aspects, the techniques described herein relate to a system, wherein the surrounding structure includes a main bag configured to at least partially enclose the space debris, the main bag including a first sack and a second sack, the second sack configured to be closed and sealed independently of the first sack.

In some aspects, the techniques described herein relate to a system, wherein: the second sack is configured to capture, enclose, and hermetically seal a contaminated space object, and the first sack is configured to enclose the second sack to prevent contamination of an outer surface of the second sack.

In some aspects, the techniques described herein relate to a method of reducing propellant for space debris capture missions including: identifying multiple debris targets for a round-trip path; approaching and capturing a first debris target in a first enclosure; and while the first debris target is still captured, approaching and capturing a second debris target in the first enclosure while retaining the first debris target in the first enclosure.

In some aspects, the techniques described herein relate to a method, further including retaining the first debris target in the first enclosure using a non-rigid retention material configured to surround the first debris target and a tether configured to link the non-rigid retention material to an interior side of the first enclosure.

In some aspects, the techniques described herein relate to a method of reducing propellant for space debris capture missions including: approaching a rotating debris target; and using a resilient capture enclosure to reduce rotation energy of the debris target, thereby reducing a need for precise maneuvering to more closely match rotation prior to debris capture.

In some aspects, the techniques described herein relate to a method, wherein the resilient capture enclosure includes sprayable foam material.

In some aspects, the techniques described herein relate to a method, wherein the resilient capture enclosure includes tethered netting.

In some aspects, the techniques described herein relate to a method, wherein the resilient capture enclosure includes a thin flexible film.

In some aspects, the techniques described herein relate to a method, wherein using a resilient capture enclosure to reduce rotation energy of the debris target includes spraying a foam material to adhere to the rotating debris target, thereby slowing rotation and smoothing a surface of the debris target and reducing tear risk.

In some aspects, the techniques described herein relate to a method, further including reducing rotation energy of the debris target after capture using a maneuvering system.

### BRIEF DESCRIPTION OF THE DRAWINGS

FIGS. 1A and 1B are schematics of capture bag hardware in accordance with aspects of this disclosure.

FIGS. 2A-2F illustrate an example approach for capturing space objects using layered flexible nets to line the capture bag in accordance with aspects of this disclosure.

FIGS. 3A-3G provide illustration of a capture bag for debris capture using foam spray in accordance with aspects of this disclosure.

FIGS. 4A and 4B provide view of a prototype capture bag in accordance with aspects of this disclosure.

FIG. 5 shows an embodiment of a large-scale capture bag in the lab with gravity-offload gantry and debris mass simulator in accordance with aspects of this disclosure.

FIG. 6 illustrates a debris removal service architecture diagram in accordance with aspect of this disclosure.

FIG. 7 illustrates a simplified model including inputs, outputs, and modules in accordance with aspects of this disclosure.

FIG. 8 includes a table showing key assumptions for the cost-benefit model in accordance with aspects of this disclosure.

FIG. 9 is a plot of propellant savings from using the capture bag described herein as the capture device in accordance with aspects of this disclosure.

FIG. 10 shows how use of the described capture bag reduces the cost of controlled and uncontrolled reentry.

FIGS. 11A and 11B show Terran Orbital prox. ox hardware as a sensing package for the capture bag payload in accordance with aspects of this disclosure.

FIG. 12 shows a plot of a capture bag payload mass versus maximum dimension of the capture bag, which corresponds to the maximum sized targets that can be safely enclosed in accordance with aspects of this disclosure.

FIGS. 13A-13D illustrate different embodiments of the capture bag for capturing multiple targets in accordance with aspects of this disclosure.

FIG. 14 shows an image of a testbed at JPL for capture bag concepts from the Asteroid Redirect Mission (ARM) in accordance with aspects of this disclosure.

FIG. 15 shows an embodiment of the capture bag being used as an end effector for the Northrop Grumman MRV in accordance with aspects of this disclosure.

FIGS. 16A and 16B illustrate an embodiment of the capture bag including a trash compacter in accordance with aspects of this disclosure.

FIG. 17 is a block diagram illustrating an embodiment of a system for capture of space debris in accordance with aspects of this disclosure.

FIG. 18 is a flowchart of an example method for reducing propellant for space debris capture missions.

FIG. 19 is a flowchart of an example method for reducing propellant for space debris capture missions.

FIG. 20 is a diagram illustrating an embodiment of a capture bag for capturing space debris in accordance with aspects of this disclosure.

FIGS. 21A and 21B are two views illustrating an embodiment of a capture bag for capturing space debris in accordance with aspects of this disclosure.

FIG. 22 is a diagram illustrating an embodiment of a capture bag for capturing space debris in accordance with aspects of this disclosure.

FIG. 23 is a diagram illustrating an embodiment of a capture bag for capturing space debris in accordance with aspects of this disclosure.

FIGS. 24A-24D are diagrams illustrating an embodiment of a method for deploying a capture bag for capturing space debris in accordance with aspects of this disclosure.

FIG. 25 is a diagram illustrating an embodiment of a deployment tube which can be used, for example, as a deployment strut a capture bag in accordance with aspects of this disclosure.

FIG. 26 is a diagram illustrating another embodiment of a deployment tube which can be used, for example, as a deployment strut a capture bag in accordance with aspects of this disclosure.

FIGS. 27A-27F illustrate an example with schematics of a Mars sample capture phase utilizing a double-layer capture bag to maintain clean zones, free from Mars dust contamination.

FIGS. 28A-28F illustrate another system and method for capturing multiple objects/debris in accordance with aspects of this disclosure.

FIGS. 29A-29H illustrate another system and method for capturing multiple objects/debris in accordance with aspects of this disclosure.

FIG. 30 illustrates an example embodiment of a hose clamp mandrel which can be used as part of a capture bag in accordance with aspects of this disclosure.

FIGS. 31A-31C illustrate a mechanized collapsible net that is configured to envelope one or more targets and provide hard points for robotic appendages.

FIGS. 32A-32C illustrate inflatable balloon deployment of bag.

FIG. 33 illustrates an embodiment of the capture bag which can be used to replace JPL's original sample orbiter capture module, an exchange that would greatly simplify mission costs and simplify design requirements for the Earth return orbiter.

FIG. 34 illustrates an embodiment of the capture bag that can be mounted to the exterior of a crewed capsule, such as NASA's Orion Capsule shown above, to perform object captures.

FIGS. 35A-35C illustrate further embodiments of the capture bag in accordance with aspects of this disclosure.

FIG. 36 illustrates an embodiment of the capture bag in stowed, deployed, and enclosed configurations within the Bishop airlock's keep-in envelope for deployable payloads.

FIG. 37 illustrates another embodiment of the capture bag scaled to fit within Nanoracks' Bishop airlock so that the entire mission can be performed in microgravity and vacuum, without requiring any external hosting.

FIG. 38 illustrates yet another embodiment of the capture bag in the form of prototype hardware built for NASA Phase 2 SBIR for debris mitigation applications.

FIG. 39 illustrates an example method for ConOps for a LEO capture bag demonstration on a smallsat bus.

FIG. 40 illustrates another embodiment of the capture bag in accordance with aspects of this disclosure.

FIGS. 41A-41C illustrate different embodiments of tools that can be included in the capture bag in accordance with aspects of this disclosure.

FIG. 42 illustrates an embodiment of an end cap that can be used for a deployment tube in accordance with aspects of this disclosure.

FIGS. 43A-43E illustrates sequential steps for forming an endcap in accordance with aspects of this disclosure.

### DETAILED DESCRIPTION

The ability to capture uncooperative objects and debris in space is helpful to the safety of space assets as well as national security interests. Described herein are systems and methods for capturing and retaining multiple objects in a single capture device for a single mission. By incorporating advanced multi-object capture mechanisms, such systems and methods can significantly improve the efficiency, versatility, and safety of debris removal operations.

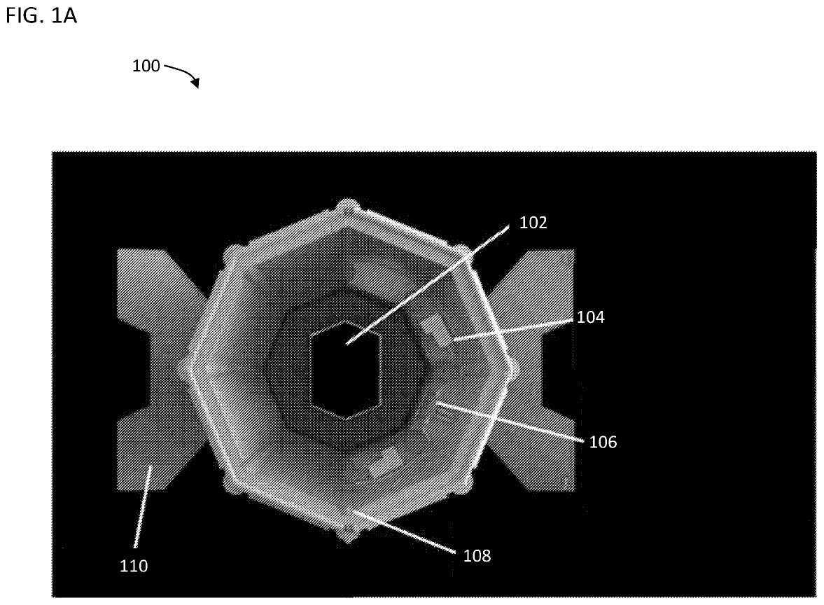

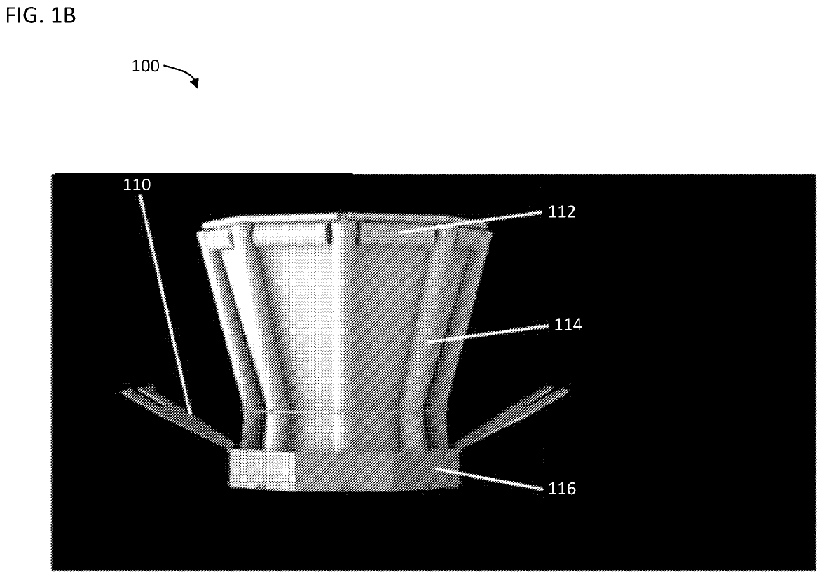

FIGS. 1A and 1B are schematics of capture bag 100 hardware in accordance with aspects of this disclosure. In particular, FIG. 1A is a top view of the capture bag 100 and FIG. 1B is a side view of the capture bag 100. The capture bag 100 includes an allocated hardware volume 102 (e.g., which can be provided by ProxOps), a bag retraction mechanism 104, an inflation system and gas storage 106, a zipper with a zipperbot 108, enclosure doors 110, closing struts 112, deployment struts 114, and a capture bag enclosure 116.

The components of the capture bag 100 are designed to be scalable, enabling embodiments of the capture bag 100 to capture debris as large as rocket bodies. As described herein, additional internal mechanisms of the capture bag 100 allow for the capture of multiple pieces of debris. For example, in some embodiments, the capture bag 100 includes multiple layers of netting that can be individually retracted to capture the multiple pieces of debris.

FIGS. 1A and 1B show a schematic of capture bag 100 hardware and major components. Some or all the components are designed to be scalable such that embodiments of the capture bag 100 can capture debris as large as 1,000 ton asteroids, rocket bodies, and defunct spacecraft, or as small as 10 cm debris objects.

It can greatly enhance efficiency and performance if a single vehicle or single mission can capture more than one space object. Obstacles to providing this capability in traditional capture systems include: inadequate or unpredictable restraint of multiple debris objects by internal capture devices; unanticipated scale-dependent effects on a capture bag and internal devices; insufficient data on debris characteristics for effective internal device design; and/or insufficient schedule allocated to the fabrication. Aspects of this disclosure recognize and address some or all of these potential obstacles.

This description advances state-of-the-art in space debris removal with a novel multi-object capture bag system. To efficiently capture and restrain multiple debris objects, aspects of this disclosure improve the capture bag system's performance characteristics, while also mitigating risks associated with debris fragmentation and the transfer of angular momentum to the host spacecraft during the capture process.

### Debris Capture Using Layers

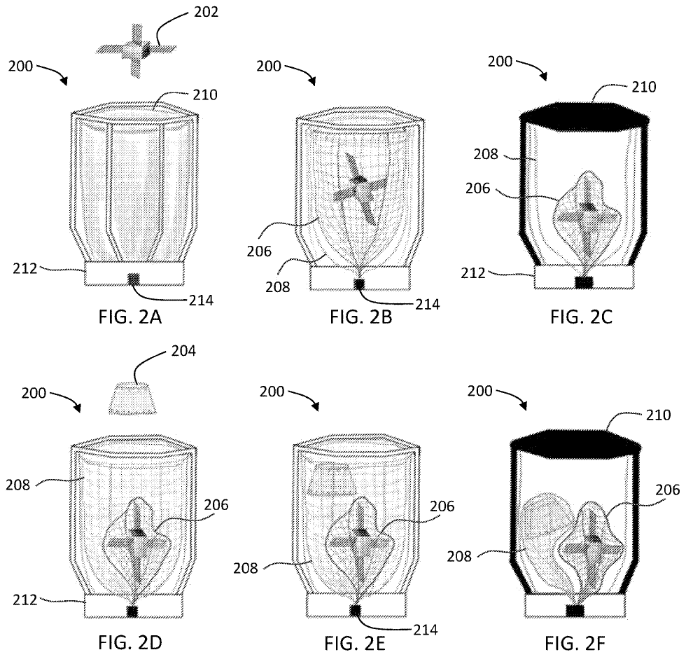

FIGS. 2A-2F illustrate an example approach for capturing space objects using layered flexible nets to line the capture bag 200 in accordance with aspects of this disclosure.

FIGS. 2A-2F include schematic depictions of a capture bag 200 hardware shown in various states. In FIG. 2A, the capture bag 200 is shown in a stowed state ready to capture an object 202. FIG. 2B illustrates the capture bag 200 in a partially deployed state. FIG. 2C illustrates the capture bag 200 in a fully deployed state having captured the first object 202. FIG. 2D illustrates the capture bag 200 in a stowed state after capturing the first object 202. FIG. 2E shows the capture bag 200 in a partially deployed state capturing a second object 204. FIG. 2F illustrates the capture bag 200 in a fully deployed state after capturing the first object 202 and the second object 204. In the illustrated embodiment, the capture bag 200 is scaled to capture objects up to 0.5 m in diameter, which can include CubeSats up to ~24 U in size or many ESPA sized spacecraft. The capture bag 200 system illustrated in FIGS. 2A-2F is an archetype of a scalable design. Certain embodiments of the capture bag 200m hardware can be designed to minimize stowed volume for a much larger unit.

With reference to FIGS. 2A-2F, the capture bag 200 includes a plurality of flexible nets including a first layer 206, a second layer 208, and additional layers (not illustrated), a main bag 210, a base 212, and a cable 214.

Multiple debris capture can use a multi-layer net concept. In phase 1 as shown in FIG. 2A, the capture bag 200 is open and ready to capture target. In phase 2 illustrated in FIG. 2B, a first target (e.g., first object 202) is captured within the first layer 206 of the flexible nets. In phase 3, the main bag 210 is sealed, and the first layered net 206 is reeled in towards the base 212 of the capture bag 200 system to contain the first target 202. FIG. 2D illustrates phase 4 in which a next target (e.g., the second object 204) is identified, and the capture bag 200 is opened and prepared. In phase 5, as shown in FIG. 2E, the next target 204 is captured within the second layered net 208. Phase 6, shown in FIG. 2F, includes a repeat of phase 3 including sealing the main bag 210 and reeling in the second layered net 208 towards the base 212 of the capture bag 200 system to contain the second target 204. This process can be repeated based on the size of the capture bag 200 and the number of layered nets included in the capture bag 200.

During close-approach rendezvous operations, the main bag 210 inflates and extends the internal netting with the bag. Once the spacecraft has maneuvered the capture bag 200 to surround the target, both the main bag 210 and the inner net seals. Each inner netting layer is attached to the motor-driven or elastic cable 214 that reels in each net separately towards the base 212 of the capture bag's 200 stowage container. This increases the chances that each captured target is isolated. When the motor 214 reels in the captured debris, the object approaches the base 212 of the capture bag 200 system and be moved as far as possible from the capture bag's 200 opening (e.g., illustrated at the top of FIGS. 2A-2F). This increases the capture bag's 200 capacity to acquire new targets. The deformable layered nets also act as a method of managing the transfer of angular momentum to the host spacecraft that occurs during target capture, thus reducing the load on the spacecraft's attitude control systems. This technology thus reduces the risk of unintended consequences such as debris fragmentation or loss of stability during target capture since the spacecraft can control the debris' orientation more effectively. The performance characteristics of this approach can be evaluated through laboratory testing of prototypes to ensure effective control of the debris during multiple object capture.

Analogous to the multi-layered net design capture bag 200 of FIGS. 2A-2E, the capture bag 200 can be lined with several smaller, flexible, lightweight bags that operate as individual capture bags, replacing the nets shown in in FIGS. 2A-2F. Just as with the netting embodiment, the main bag 210 inflates and the plurality of bags open with the main bag 210. The plurality of interior bags can enable multiple fully-sealed containment areas. This may be advantageous over netting if the debris contains leaking liquids or has the possibility of fragmenting into many small pieces of debris. The number of captures depends on the number of inner layers added to the capture bag 200 and the size of the scalable capture bag 200.

### Capture Using Foam or Sprayed Material

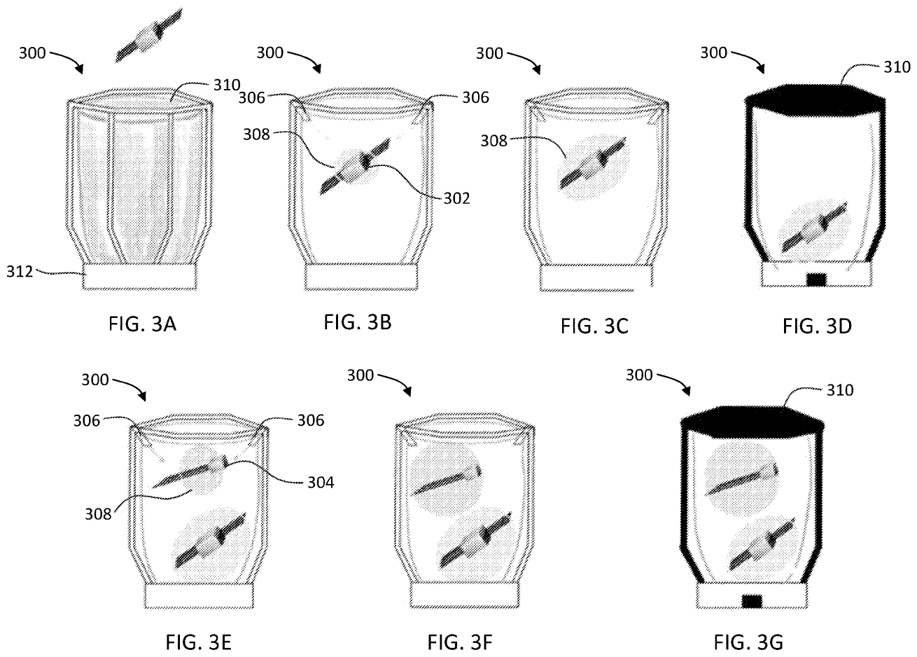

FIGS. 3A-3G provide illustration of a capture bag 300 for debris capture using foam spray in accordance with aspects of this disclosure. The capture bag 300 of FIGS. 3A-3G includes a plurality of foam nozzles 306, a main bag 310, and a base 312.

In phase 1 shown in FIG. 3A, the main bag 310 of the capture bag 300 is opened to capture a target. FIG. 3B illustrates phase 2 where the foam nozzles 306 spray sticky, non-brittle foam 308 onto a first target 302. As shown in phase 3 illustrated in FIG. 3C, the foam 308 sticks to the first target 302 and expands as the first target 302 enters the main bag 310. In phase 4 shown in FIG. 3D, the first target 302 is captured and the main bag 310 of the capture bag 300 closes. FIG. 3E illustrates phase 5 where a second target 304 is identified, and the main bag 310 is opened. The nozzles 305 spray the second target 304 with foam 308, which accumulates to encompass the second target 304 as shown in FIG. 3F. Phase 6 shown in FIG. 3G is similar to phase 4 where the second target 304 is captured and the main bag 310 of the capture bag 300 closes. This process can be repeated based on the size of the capture bag 300 and the amount of foam stored for use by the plurality of foam nozzles 306.

Equipping the capture bag 300 with foam sprays 306 is another approach to multi-target deorbiting, as shown in the FIGS. 3A-3G. Space-ready, non-brittle, sticky foams 308 can further constrain debris within the capture bag 300 and can help damp the angular momentum of the debris. Once the main bag 310 is inflated, and while the debris is entering the main bag 310, the nozzles 306, which can be attached to the spreaders of the main bag 310, spray the debris with foam 308. The adhesion then makes it easier to capture and contain debris. Since the foam 308 can conform to complex shapes, this can improve the capture bag's 300 ability to capture and constrain debris with appendages, such as solar panels. The foamed target can adhere to the bag or the next foamed target, which can improve the capture bag's 300 capability of constraining multiple targets. Furthermore, the foam 308 can provide a layer of protection around the captured debris and prevent damage to the capture bag 300 from captured objects.

Some validation relates to the Asteroid Redirect Mission (ARM). The ARM mission aimed to capture a <8 m asteroid using an inflatable capture bag and transport it to a distant retrograde lunar orbit for astronaut visits. Although the ARM mission was canceled in 2017, the research conducted on the capture bag concept provides background for the present disclosure.

Aspects of this disclosure related to the Apis capture bag address key risks and feasibility issues through robust engineering and scientific practices. These include bag-target-carrier dynamics, rotating capture target dynamics, bag rip and integrity issues, bag scaling, inflatable component leakage, detailed soft goods designs, bag deployment dynamics, enclosure box gas entrainment, stowage issues, and more. Stowed, partially deployed, and deployed states have been demonstrated using prototype capture bags.

### Multi-Debris Capture

Traditional debris capture systems are only configured to capture once instance of debris. In contrast, if the size and mass of two pieces of debris allow them to both fit within a single one of the capture bags described herein, there may be opportunities to capture more than one piece of debris in the same orbital plane before performing the deorbit maneuver. This results in overall Δv (e.g., total change in velocity) budget savings by reducing the number of deorbit maneuvers that must be performed to deorbit an entire cluster of debris. Depending on the distribution of debris within orbital planes for each cluster and the size of individual pieces of debris, realistic scenarios for large scale debris clean up operations fall somewhere between the scenario where debris is collected one-at-a-time and a scenario where there are always two pieces of debris that may be collected together. Our analyses show, that in the scenario where a capture bag is always able to pick up two pieces of debris per orbital plane before deorbit maneuvers total fuel usage of a large-scale debris clean-up effort can be reduced by up to 35% of the baseline usage.

Orbital debris poses a significant threat to space operations, astronaut safety, and satellite functionality. The debris is composed of abandoned vehicle stages, non-functional satellites and collision-induced material fragments. Moreover, dodging debris increases operational costs while future cascading collisions have the potential to render entire orbits unusable for extended periods. Is it desirable to solve this important problem as the national economy and national defense are becoming increasingly reliant on space infrastructure for vital services such as communications, financial exchange, weather monitoring, observation of natural resources and human activity, multispectral imagery, radar, and more. NASA has the responsibility to help protect vital commercial and government assets in space by remediating debris using the most cost effective and scalable means. Addressing the challenges of debris remediation is also crucial to preserving the accessibility and sustainability of space. The capture bag solutions described herein provides a cost-effective, flexible, and powerful tool that enables scalable and efficient commercial services for debris removal, while minimizing the risk of generating unintended secondary debris during the capture process.

### Additional Benefits

In order to address the above problems, aspects of this disclosure relate to a capture bag solution called the Apis Capture Bag, or the capture bag for short. Apis is the genus name for honey bees because the capture bag collecting spacecraft debris imitates a foraging honeybee. In some embodiments, the capture bag described herein includes flexural inflatable struts (e.g., the closing struts 112 and deployment struts 114 of FIGS. 1A and 1B) that are configured work similar to muscles to open and close a rip-stop bag. Embodiments of the capture bag further include an optional robotic zipper configured to seal the bag around the target, optional internal nets to secure multiple target debris items inside the bag, and cable systems to retract the bag and constrain the movement of captured debris items. Proximity operations sensors can be included as part of either the bag payload or the carrier vehicle. Capture bags can fully envelop targets and seal against small debris using the robotic zipper before making physical contact. Tumbling targets can be captured inside the bag and then de-spun via debris-to-bag mechanical interactions, or the carrier vehicle can match primary axis rotations prior to capture, at which point de-spin of the coupled system can be accomplished by the spacecraft's attitude control system (ACS). The described capture bag technology can be used either as a body-mounted payload on an active debris removal (ADR) dedicated spacecraft or for use as a robotic arm end-effector on an in-space servicing vehicle such as Northrop Grumman's mission robotic vehicle (MRV).

The described capture bag improves or reduces the cost of debris mitigation in multiple ways. The capture bag according to aspects of this disclosure can remove debris of any shape below the maximum size constraints of a given bag design, regardless of whether pre-launch servicing accommodations were made on the target. Other approaches—e.g., robotic grappling, magnetic attachment, and other constraining mechanisms—require either the target to have been designed in advance for servicing or a unique end-effector for each type of debris, severely limiting the number and type of targets that can be removed by such methods.

A spacecraft using the described capture bag to remove a debris target does not have to expend as much propellant or time and operational cost precisely matching the spin state of the target. Depending on the target's relative mass and the carrier vehicle, the capture bag can in many cases fully enclose an object tumbling about arbitrary axes and then de-spin the target within the bag. In other cases, only an approximate spin match is required, and in no case is a precision hard dock required. These factors reduce the total propellant and other resources required to perform large-scale debris deorbit campaigns, while also increasing the total population and diversity of removable targets.

Embodiments of the described capture bag can be equipped to capture and constrain multiple pieces of relatively small debris within one bag, allowing for propellant-optimized routing between elements of a population of targets. This enables large savings in propellant, time, and operational resources relative to all other known solutions which are limited to a single debris capture per mission.

The described capture bag design can be scaled to sizes that can capture large defunct spacecraft and spent rocket bodies. Similar design architecture can be used for an asteroid redirect mission to retrieve a 500 ton, 8 m diameter asteroid. The bag architecture is inherently scalable to handle massive targets. The described capture bag can be used in future asteroid mining architectures with even larger targets.

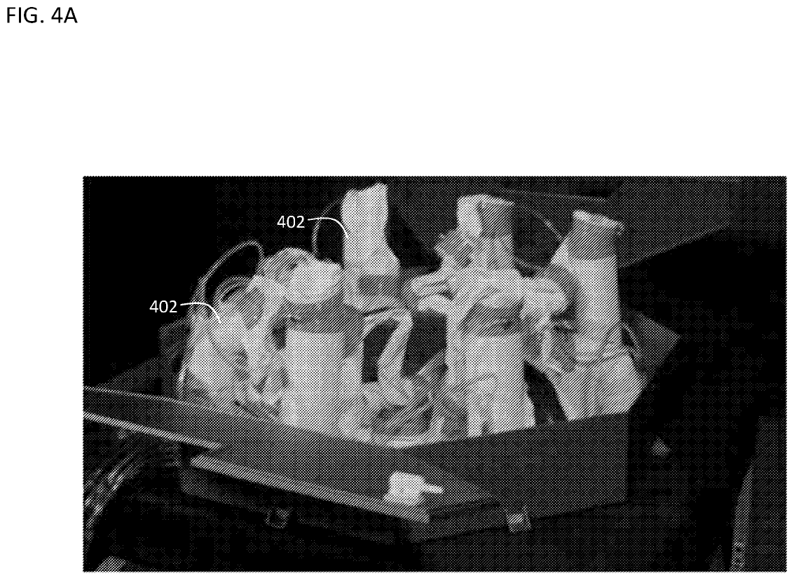

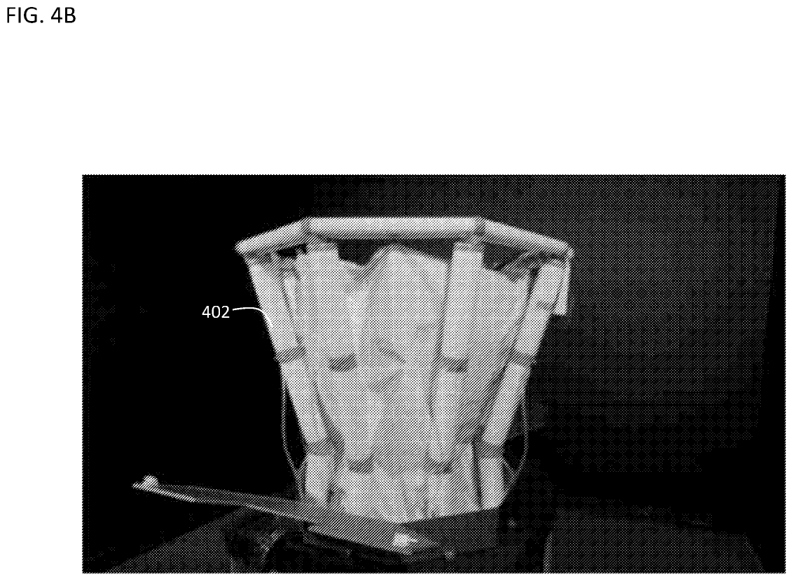

Considerations for capture bags include: rotating capture target dynamics, bag rip robustness, bag scaling, inflatable component sealing, bag deployment dynamics, stowage, and several other factors. FIGS. 4A and 4B provide view of a prototype capture bag in accordance with aspects of this disclosure. In particular, FIG. 4A shows the capture bag in a partially deployed state and FIG. 4B shows the capture bag in a deployed state. FIGS. 4A and 4B illustrate that the capture bag can be caused to unfold from a stowed configuration (FIG. 4A) by the inflation of one or more flexible pressure-tight deployment tubes 402.

The prototype of FIGS. 4A and 4B is scaled to capture objects up to 0.5 m in diameter, which can include CubeSats up to ~24 U in size or many ESPA sized spacecraft. This system was design optimized for technology demonstration, not packaging efficiency and is an archetype of a scalable design.

A laboratory prototype of a largescale capture bag suitable for fully enclosing 3-5 m objects can be demonstrated using a capture test bed.

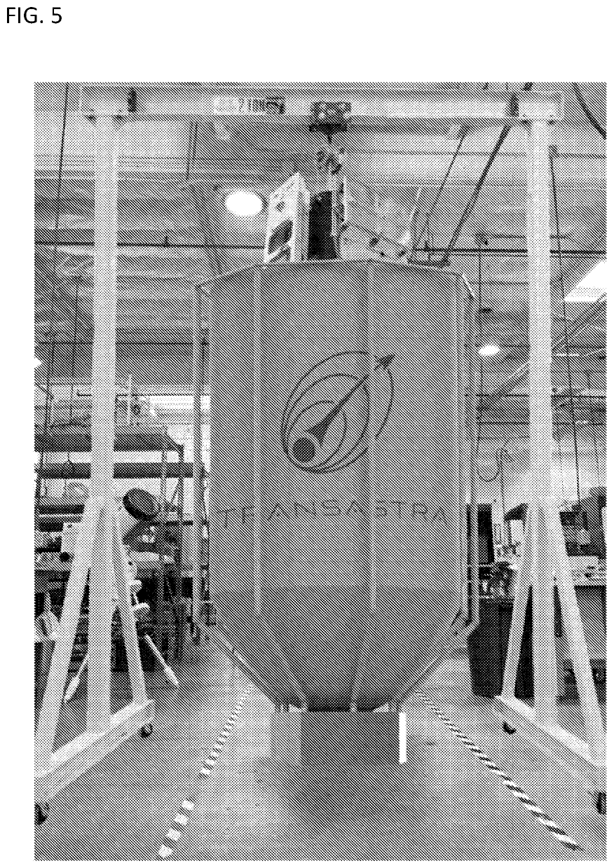

FIG. 5 shows an embodiment of a large-scale capture bag in the lab with gravity-offload gantry and debris mass simulator in accordance with aspects of this disclosure.

The capture test bed allows for controlled rotation of the capture bag, coupled with a gantry for gravity off-load and independently-controlled rotation of a debris mass simulator. It can validate the modeled dynamic and structural limitations of the inflatable booms and capture bag materials. These tests determine the structural and rotational characteristics of debris that is suitable for disposal using the capture bag and informs quantitative requirements for the flight capture bag payload.

### Debris Removal Architecture

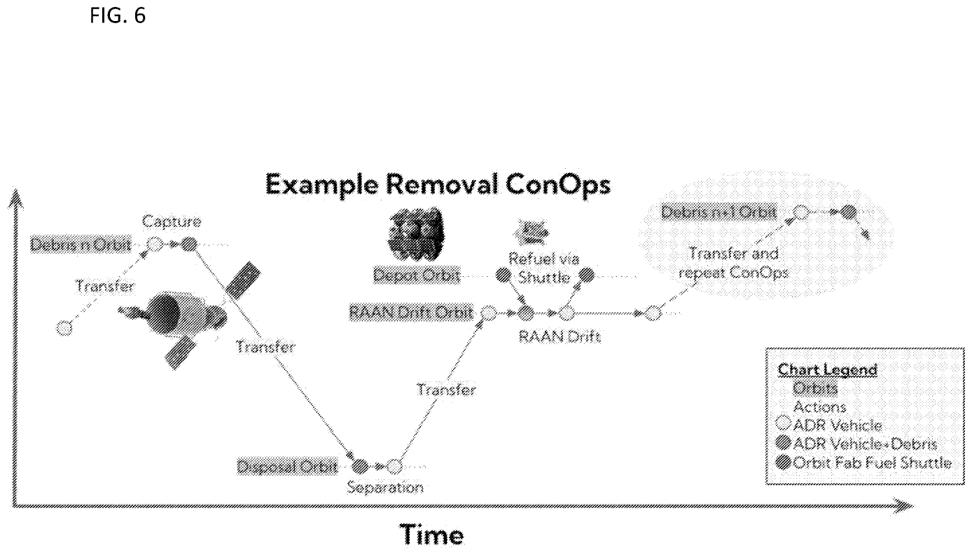

FIG. 6 illustrates a debris removal service architecture diagram in accordance with aspect of this disclosure. FIG. 6 shows the major steps of the architecture including an ADR vehicle (adapted here to show a vehicle carrying an embodiment of the disclosed capture bag), deorbiting, transfer to a refueling orbit where a depot/shuttle refuel the ADR vehicle, and continuing to the next piece of debris. This concept is taken as the lowest cost architecture for controlled/uncontrolled deorbit of large debris in the NASA ODR report. This analysis uses this architecture as a baseline, from which we make improvements by using capture bag as the debris capture device.

The schematic of FIG. 6, plots average altitude over time; the relative altitudes implied are variable depending on inclination, delta-V, and time. This schematic depicts an ADR vehicle transferring to a debris removal target, capturing the debris, performing a deorbit maneuver, then transferring to a holding orbit to be refueled, and continuing the cycle by transfer to the orbit of the next piece of debris. This mission profile can be performed with any capture device and assumes the ADR can capture only one article of debris at a time.

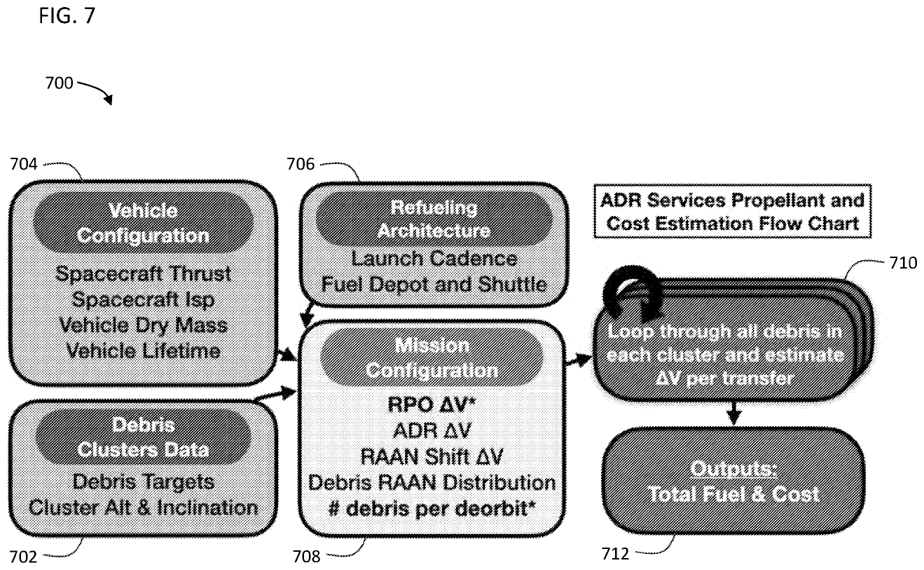

FIG. 7 illustrates a simplified model including inputs, outputs, and modules in accordance with aspects of this disclosure.

FIG. 7 provides a flow chart of the model for cost-benefit analyses of debris remediation architectures. This flow chart can be used to validate past models for other approaches prior to analysis that showed capture bag to be superior with higher ROI.

Using the flow chart of FIG. 7 of the model for cost-benefit analyses of debris remediation architectures, past models for other approaches can be validated prior to analysis that showed capture bag to be superior with higher ROI.

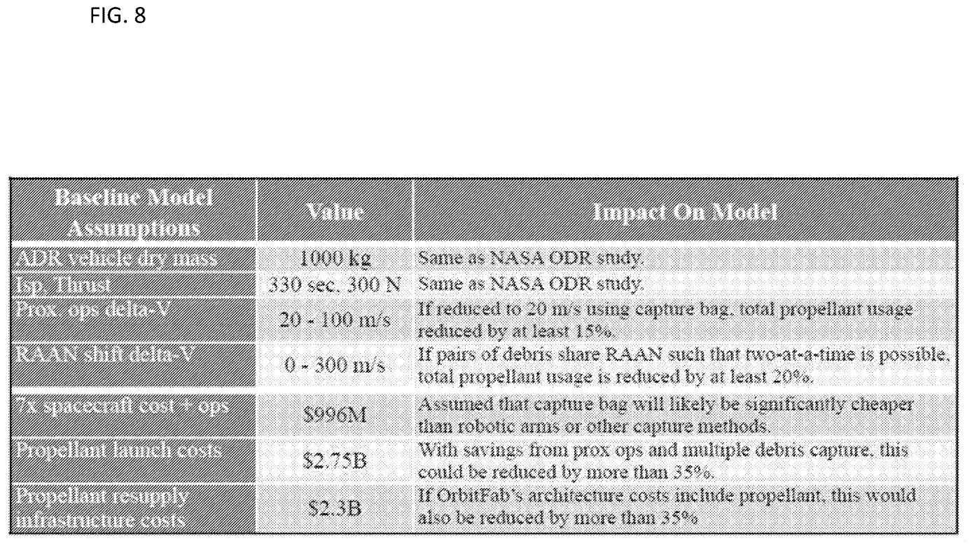

Inputs to the cost-benefit model 700 include 1) debris cluster data 702 specifying the types, sizes and locations of debris to be collected, 2) vehicle configuration 704 giving the specifications of a spacecraft host, and 3) refueling architecture 706 defining the depot/shuttle architecture that can be used to provide propellant to a spacecraft after debris deorbit. These inputs feed into the mission configuration module 708 where the main inputs are provided that vary when using the capture bag as the spacecraft's capture mechanism. All of these inputs feed into an iterative loop 710 over all the debris in each cluster, calculating Δv, propellant usage, and mission durations for each scenario. The outputs 712 are costs and propellant usage required to perform a massive-scale debris removal campaign. After validating the model against a NASA ODR report's findings, the model can be run using the capture bag performance assumptions to find the cost savings of using the capture bag for target acquisition. The ranges of various model input parameters associated with the use of capture bag and other proposed vehicles can be studied. FIG. 8 includes a table showing key assumptions for the cost-benefit model in accordance with aspects of this disclosure.

### Benefits and Multi-Use Bag

The most cost-effective ADR vehicle architecture explored in the NASA ODR report, using bi-propellant for both orbit transfers and proximity operations, was an input for our modeling. No assumption is made regarding any particular type of capture mechanism, but some approaches havea capture mechanism that can only deal with one debris item at a time. In addition, some critical assumptions of traditional architecture can be favorably influenced by the use of the capture bag. The first is that proximity operations require 100 m/s of Δv to meet the precise rotational state matching for rendezvous and grappling or docking. The disclosed capture bag advantageously allows for looser tolerances on the relative angular rates between the ADR vehicle and the debris. Capturing slowly tumbling debris without having to precisely align to its rates and axes of rotation can reduce the Δv expenditures, depending on the maximum allowable rates permitted by described capture bag design.

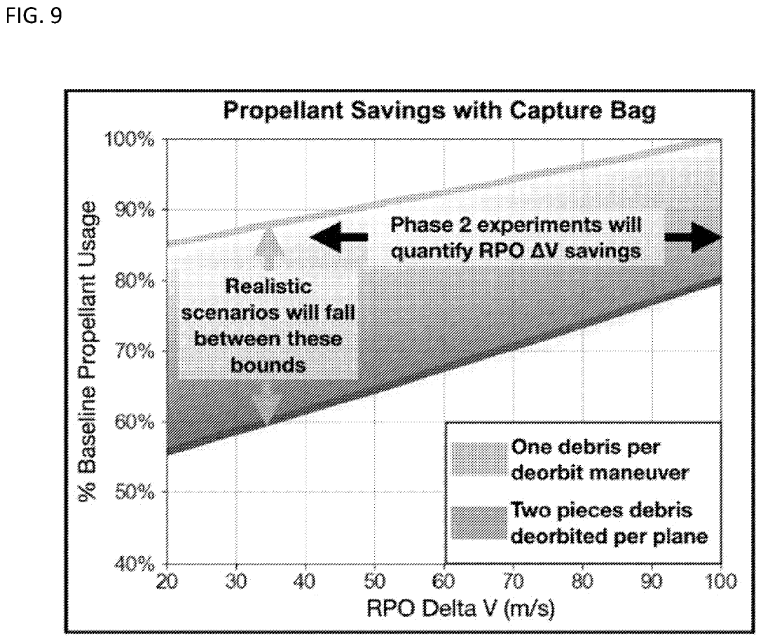

FIG. 9 shows that modeling demonstrates that if using the disclosed capture bag allows for halving the required proximity operations Δv, this result in an approximate 10% reduction in overall mission propellant usage, the main driver for cost. The overall savings may be even greater, though, as in many mission scenarios, capture bag can retrieve more than one piece of debris per deorbit maneuver. This enables enhancements to the concept of operations shown in the figures, in which multiple pieces of debris may be captured before deorbit and refueling. This results in overall Δv savings by reducing the number of required maneuvers to deorbit each cluster of debris. Depending on the distribution of debris within orbital planes for each cluster and the size of individual pieces of debris, realistic scenarios for large scale debris clean-up operations fall somewhere between a one-by-one collection scenario and an optimistic scenario where there are always two pieces of debris that may be collected together.

FIG. 9 is a plot of propellant savings from using the capture bag described herein as the capture device in accordance with aspects of this disclosure. By reducing proximity operations Δv and creating the ability to de-orbit multiple debris items at a time, the described capture bag can save up to nearly half of the total propellant resupply costs required for large orbital debris cleanup.

If the capture bag allows rendezvous Δv to be halved, total propellant required can be cut by 10%, reducing the NASA predicted costs from $7,500/kg to $6,850/kg. The figure also shows the total fuel usage can be further reduced to just 65% of the baseline usage if the capture bag is always able to pick up two pieces of debris per orbital plane before deorbit maneuvers. This reduces the NASA predicted costs to $5,300Ikg. Other approached may involve a total cost of $4,000/kg by neglecting some propellant launch costs, but even with this assumption, the benefits of capture bag reduce the cost of the refueling architecture and operations, bringing the predicted costs to $3,100/kg. Even given all of these quantitative benefits, the benefits of the described capture bag goes well beyond the launch mass dollar savings shown in the figures. By allowing for looser proximity operations and rendezvous in place of precision docking, the capture bag as described herein can reduce the requirements on the ADR vehicle design and mission operations, saving considerable cost above that which we have thus far been able to quantify.

A benefit of collecting more than one piece of debris is illustrated by the bounding range of scenarios in the figure above (blue and orange lines).

Overall, the results from the initial cost-benefit modeling applying the capture bag modifications show the potential for a large saving in overall cost. As previously shown, this is a result of reducing total propellant required to perform proximity operations and rendezvous plus the possibility of capturing more than one piece of debris per orbital plane. FIG. 9 summarizes the costs and benefits for various debris remediation methods and shows reduced costs for controlled and uncontrolled reentry.

The described capture bag and the spacecraft designed to host this payload satisfies several design parameters to effectively remove debris from orbit. Design parameters for the capture bag system and host spacecraft reflect considerations of adaptable and safe orbital debris remediation, including rendezvous and proximity operations with target debris, safe disposal procedures, angular momentum transfer during capture, the payload interface to the host spacecraft, host spacecraft guidance, navigation, and control (GNC) and propulsion subsystem parameters, and the characteristics of the target debris that can be captured by the bag system.

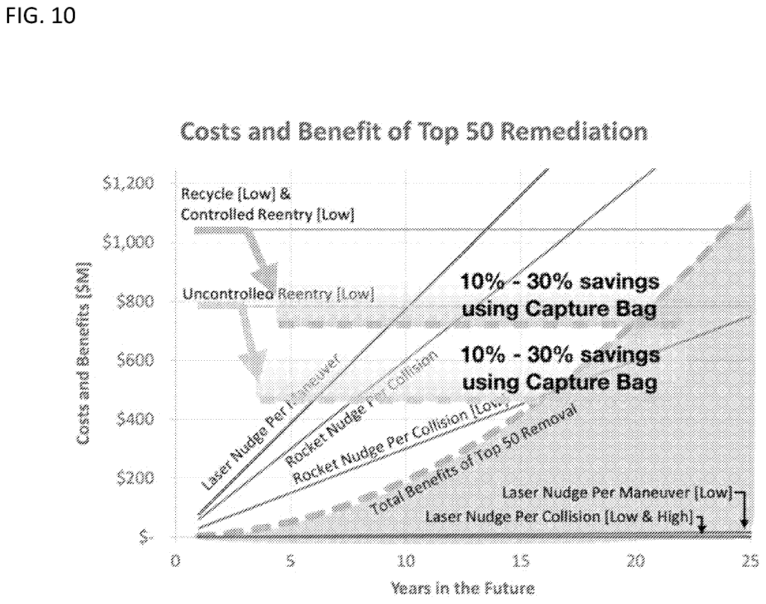

FIG. 10 shows how use of the described capture bag reduces the cost of controlled and uncontrolled reentry by 10% to 30%, making it a more cost competitive approach to remediation while simultaneously providing superior debris capture feasibility.

As part of one definition, the payload can include sensors, software, and algorithms for proximity operations with partners. In some embodiments, sensing capabilities that they have been demonstrated for proximity operations and rendezvous can be incorporated into the described capture bag. On example sensor is Terran Orbital's FPGA Luminary-detect Star Tracker (FLST). The sensors and CubeSats used to demonstrate the sensors are shown in FIG. 10. In some embodiments, a few of these visual sensors are sufficient and can be integrated with the body-mounted payload version of the capture bag. These include stereo cameras placed at the base of the bag, within the deployed capture bag to obtain visual and ranging information on the target throughout the capture sequence. Additional sensors can be placed on the spacecraft to aid in initial acquisition and mid-field rendezvous. When the described capture bag is used as an end-effector on Northrop Grumman's MRV, the MRV is equipped with all sensors necessary to position the capture bag around a target.

### Capture Bag Scaling and Storage

Significant variability exists among debris objects in terms of sizes, shapes, orbit, and spin rates. Accordingly, the described capture bag (and any cost-effective debris capture device) is designed to be adaptable to different classes of target objects. Based on a study survey focused on active satellites and orbital debris population, there are approximately 7,600 operational spacecraft in orbit, 90% of which are in low earth orbit (LEO). There are about 1 million debris objects larger than 1 cm, and roughly 2,000 rocket bodies in orbit. Most of the debris is in LEO, with the greatest concentration located at altitudes between 800 and 1,000 km. Based on a quickly growing number of spacecraft planned for deployment in the decade of the 2020s, especially large LEO constellations, rocket bodies and defunct LEO satellites are examples of typical targets for capture.

Further design considerations for the capture bag can include quantitative elements of the rendezvous operations and techniques for constraining the momentum nulling for the host spacecraft given such targets. In some embodiments, the described capture bag designs can be scaled with masses ranging from single digits of kilograms to approximately five hundred kilograms. At the smaller end of the range, capture bags can be stowed in a Northrop Grumman ESPAStar or similar payload port and deployed as an end effector on a robotic arm. The larger end of the range embraces bags similar to those studied by JPL and NASA for the ARM mission, capable of capturing objects massing up to 1,000 tons. The size range of bags can also be extended to include those that can be integrated with large scale asteroid mining vehicles using the full capacity of commercial super heavy launchers such as the SpaceX Starship and the Blue Origin New Armstrong system. These movable flexible enclosures can be capable of capturing asteroids massing in the tens of thousands of tons.

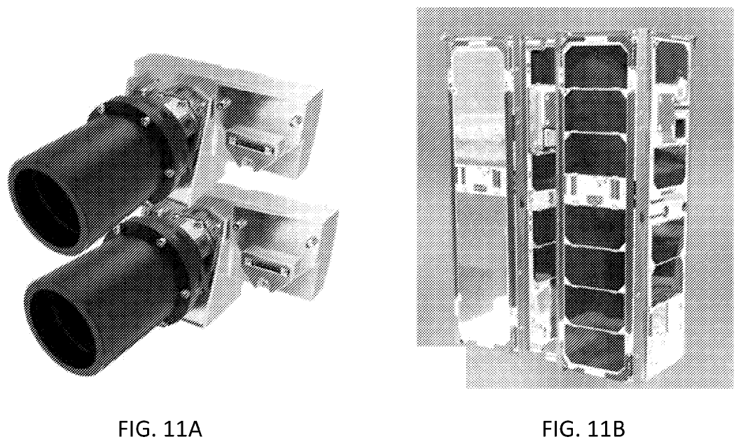

FIGS. 11A and 11B show Terran Orbital proximity operations hardware as a sensing package for the capture bag payload in accordance with aspects of this disclosure. In particular, FIG. 11A shows Two Terran Orbital FPGA Luminary-detect Star Tracker (FLST) used as stereo cameras for ranging of debris targets. FIG. 11B shows Terran Orbital CubeSat Proximity Operations Demonstration (CPOD) mission spacecraft which demonstrated their prox. ops and rendezvous sensing, software, and algorithms.

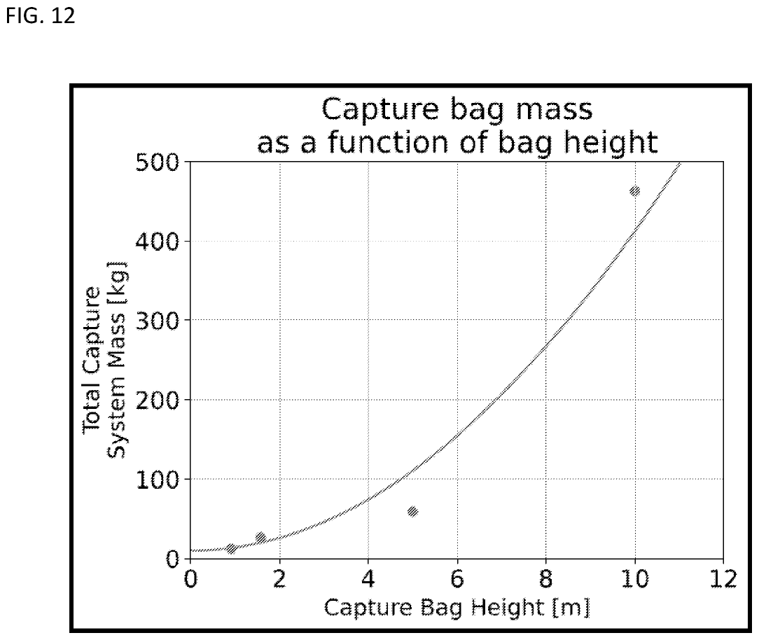

To enhance each capture bag's ability to contain debris in each design scenario, the bag opening and height can also be scaled based on the size of the largest target under consideration for each bag design while accommodating uncertainty in proximity operations and rotational precession of the target. The described capture bag can be scaled to capture the debris from any angle, but for high aspect ratio objects similar to SL-8 rocket bodies (which are long and thin), the baseline bag design is taller than it is wide. Therefore, the bag height and payload mass increases for increasing debris target length. FIG. 12 shows the relationship between bag height and total capture system mass for capture bag systems with moderate aspect ratios of at most 2:1, roughly similar to the bag concept. Some large aspect ratio targets in LEO are gravity gradient stabilized over time, such that rotation around the principal axis is rare, allowing capture from the end, rather than the side. For “flat-spin” rotations, wider capture bags can be used.

FIG. 12 shows a plot of a capture bag payload mass versus maximum dimension of the capture bag, which corresponds to the maximum sized targets that can be safely enclosed in accordance with aspects of this disclosure. For large pieces of debris of concern, payload mass is well within the capabilities of current and proposed logistics spacecraft; cost compares favorably to hardware costs for robotic arms, in addition to other compounding cost-saving benefits from using a capture bag.

### Multiple Object Capture Devices

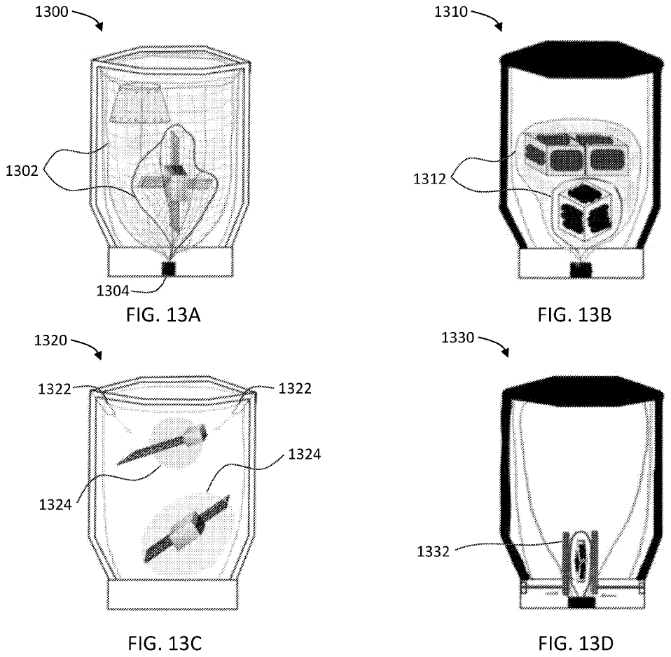

FIGS. 13A-13D illustrate different embodiments of the capture bag for capturing multiple targets in accordance with aspects of this disclosure. Each of these embodiment involves the addition of structures or devices within the capture bag that allow for the safe containment of multiple debris. For large spacecraft and rocket body capture, up to two targets can be captured and contained in a bag, which can cut orbital maneuvering Avs roughly in half. For smaller, low aspect ratio orbital debris and CubeSat scale objects, a single bag can capture and contain up to a dozen objects at a time.

in the embodiment of FIG. 13A, the capture bag 1300 includes multiple nets 1302 that can independently enclose, retract, and stow each object within the enclosure. FIG. 13B illustrates an embodiment of the capture bag 1310 including multiple additional internal bags 1312 that can constrain small debris or leaking fluids. In the embodiment of FIG. 13C, the capture bag 1320 includes nozzles 1322 configured to spray foam 1324 onto debris as it enters the bag. FIG. 13D illustrates an embodiment of the capture bag 1330 having a compacter 1332 configured to compress capture debris. The capture bag 1300 of FIG. 13A is advantageous in many cases with embodiment allowing for up to ten internal stowage nets of small debris.

In some embodiments, the capture bag 1300 includes layered flexible nets to line the capture bag, as seen in the FIG. 13A. During close-approach rendezvous operations, the main bag inflates and extends the internal netting 1302 with the capture bag 1300. Once the spacecraft has maneuvered the capture bag 1300 to surround the target, both the main bag and the inner net 1302 seals. Each inner netting 1302 layer is attached to a motor-driven cable or elastic cable 1304 that reels in each net separately, thus ensuring isolation of each captured target. The deformable layered nets 1302 also act as a method of managing the transfer of angular momentum to the host spacecraft that occurs during target capture, thus reducing the peak loading on the spacecraft's attitude control systems. This technology thus reduces the risk of unintended consequences such as debris fragmentation or loss of stability during target capture since the spacecraft can control the debris' orientation more effectively.

Analogous to the multi-layered net design, the capture bag 1310 of FIG. 13B can be lined with several smaller, flexible, lightweight bags 1312 that operate as individual capture bags 1312. Just as with the netting, the main bag inflates and the inner linings 1312 open with it. Interior bags 1312 can enable multiple fully-sealed containment areas. This may be advantageous to netting in the event that debris is leaking liquids or has the possibility of fragmenting into many small pieces of debris. The number of captures depends on the number of inner layers added to the Capture Bag and the size of the scalable capture bag 1310.

Equipping the capture bag 1320 with foam sprayers 1322 is another approach to multi-target deorbiting with the capture bag 1320 as shown in FIG. 13C. Space-ready, non-brittle, sticky foams 1324 can further constrain debris within the capture bag 1320 and can help damp their angular momentum. Once the capture bag 1320 is inflated, and while the debris is fully enclosed by the bag, two nozzles attached to the spreaders of the bag spray the debris with foam 1324; the adhesion then makes it easier to capture and contain debris. Since the foam 1324 can conform to complex shapes, this can improve capture bag's 1320 ability to capture and constrain debris with appendages, such as solar panels. The foamed target can adhere to the bag or the next foamed target, which can improve the capture bag's 1320 capability of constraining multiple targets. Furthermore, the foam can provide a layer of protection around the captured debris and prevent damage to the capture bag 1320 from captured objects.

Aspects of this disclosure can address the challenges of orbital debris removal by maturing an innovative and scalable capture bag solution. The technical aspects cover the capture bag's interaction with tumbling objects, its scalability to accommodate debris of various sizes, the ability to constrain multiple targets within a single bag, and the potential cost reductions it offers for large-scale debris removal missions. Additionally, the disclosed technology relates to a space-qualified, flyable payload focusing on detailed cost modeling and the definition of interfaces with host spacecraft such as Northrop Grumman's MRV. By addressing these aspects, this disclosure provides an efficient, reliable, and cost-effective solution for orbital debris removal that meets the needs of both NASA and the broader commercial market.

### Technical Aspect 1: Rotational Dynamics Management

A first set of technical aspects addresses the interaction between the disclosed capture bag and debris with varying rotational states to optimize the capture process and enhance the capture bag's robustness. By both experimental investigation and extensive analysis of the impact of tumbling objects on the capture bag's rendezvous requirements, stability, and retraction and securing mechanisms, a tool for a wide range of debris characteristics can be provided.

There are likely limitations on the differences in primary-axis rotation angular rates between the target objects and the capture bag. Based on the relative angular rates about target primary rotational axes, the tolerances on rendezvous and rate matching can be constrained in order to refine Δv estimates for proximity operations. The capture bag can have significantly relaxed rendezvous parameters including alignment and rate matching compared to deorbit solutions requiring robotic arm grappling. These Δv savings for each proximity operation can reduce the overall fuel costs of a large-scale debris remediation program, leading to lower overall architecture costs.

There are likely acceptable tumbling limits for target objects. by establishing the operational limits for target object tumbling, the overall robustness of capture bag can be improved while identifying debris objects in more complicated rotational states. This further refines the families of debris objects that can be feasibly captured by the capture bag but cannot be captured by other methods.

Potential hazards include ripping, tearing, or snagging. A major advantage of the capture bag described herein is the capability to fully enclose a piece of debris before making contact.

The capture bag can have dynamical stability during the debris capture process. By investigating the capture bag's stability after capturing objects in various rotational and tumbling conditions, parameters for the host spacecraft GNC controllability can be obtained. In some embodiments, the spacecraft can restore its attitude and rotation state after disturbances from the capture process.

There may be an influence of tumbling objects on the capture bag's retraction and securing mechanisms. By understanding the impact of initially tumbling objects on these mechanisms, the capture bag can successfully constrain and secure debris in a wide range of conditions. The retention mechanisms allow for the host spacecraft to perform predictable slews and maneuvers after capture, but the retention process must be possible after a range of unpredictable capture dynamics.

Additional angular momentum management strategies can help with control. The capture bag can be outfitted with rotational gimbal mechanisms and/or integrated reaction wheels to manage angular momentum changes during capture internally to the payload with less influence on the host spacecraft. Furthermore, a variant of the capture bag can be an end-effector on the robotic arm on Northrop Grumman's MRV spacecraft.

### Technical Aspect 2: Capture Bag Scalability

A second set of technical aspects focuses on understanding and optimizing the scaling of the capture bag for different sized targets, ensuring a versatile debris removal solution. Parameters for bag size, joint scaling, and inflatable strut design can provide a capture bag that can reliably and safely accommodate a wide range of debris.

Bag size can be sufficient to reliably fully enclose targets before making contact, ensuring no unconstrained debris is incidentally generated. Determining the necessary bag dimensions for different debris sizes helps the capture bag effectively enclose and capture various targets while minimizing the risk of generating additional debris during the process.

Scaling of joints, mechanisms, inflatable struts, and bag materials can be advantageous. Scaling the capture bag's components provides a robust design that can withstand the stresses and loads associated with capturing larger debris. For larger joints, there can be a potential for increased leakage in scaled-up joints. Inflatable strut sizes: Inflatable struts can provide non-linear scaling. Bag materials: As the bag itself scales, it may utilize materials with varying strength, flexibility, and durability to ensure its effectiveness.

Scaling may impact inflation/deployment and retraction mechanisms and dynamics. The ability to efficiently deploy and retract the capture bag for different sized targets may be important for its overall performance. Understanding the scaling implications on these mechanisms helps improve their design and operation.

Target size can affect spacecraft control and maneuverability. Capturing larger debris impacts the host spacecraft's ability to control and maneuver after capture. Results from investigating these potential effects helps refine spacecraft parameters and develop appropriate strategies to maintain control during debris removal operations.

### Technical Aspect 3: Multi-Target Confinement

A third technical aspect aims to design and improve internal mechanisms within the capture bag that can effectively constrain multiple targets without generating incidental debris. Aspects of this disclosure provide innovative and efficient solutions for capturing multiple debris objects in a single mission, significantly reducing the overall cost of large-scale debris remediation efforts:

Various hardware options are provided for constraining multiple objects within the bag when the bag is either open or closed. Identifying and analyzing different confinement methods helps identify effective and practical solutions for securing multiple debris objects within the capture bag. Being able to use a large bag to pick up multiple smaller objects before performing a deorbit maneuver has the potential to be a massive cost-saving for the overall architecture. Some examples include multiple internal lightweight bags. Incorporating smaller bags within the capture bag helps segregate and constrain multiple debris objects, minimizing the risk of contact and potential damage during the removal process. Some examples include internal nets. Using flexible netting systems inside the capture bag to provide additional confinement for multiple targets. Some examples include foams or similar sprayed materials. Space-compatible foams can be used, for example those that can expand and conform to the shapes of various debris objects and constrain debris using surface tension.

Multi-target confinement mechanisms can impact capture bag deployment and retraction. Internal mechanisms can be incorporated for multiple debris containment on the bag's deployment. However, this can be more difficult or different when an existing piece of debris is already constrained within the bag.

There may be different effects of multi-target confinement on host spacecraft control and maneuverability. For example, capturing multiple debris objects within the capture bag may impact the host spacecraft's ability to control and maneuver after capture.

### Technical Aspect 4: Architectural Modeling

A fourth technical aspect is to demonstrate the cost reductions associated with using the capture bag for large-scale debris removal programs through orbital mechanics and broader architectural modeling. By comparing the capture bag's performance and cost-effectiveness to other capture mechanisms, such as robotic arm grappling, the benefits of our solution in terms of mission efficiency and overall architecture costs can be shown.

The relaxation of rendezvous requirements can reduce the required prox ops Δv. Such relaxed rendezvous requirements on Δv and fuel consumption provides cost savings associated with using the capture bag compared to other capture methods that demand more precise alignment and rate matching.

The orbital dynamics and mission design can impact the feasibility of capturing multiple objects. The impact on the overall architecture costs can be modeled to show when it's feasible to pick up multiple items at once to help demonstrate cost savings and efficiency improvements associated with using the capture bag for multi-object debris removal. One example of modelling that shows the cost savings is illustrated in FIG. 10, which is discussed above.

Dropping off debris at an intermediate orbital storage depot as opposed to having to deorbit all pieces of debris can also have an impact of the overall costs. The cost implications of alternative debris disposal methods, such as using orbital storage depots, can affect the flexibility and cost-saving potential of the capture bag in different debris removal scenarios. A drop-off disposal platform may also serve as a disposal location for other methods of debris capture besides our capture bag as well. The drop-off disposal platform can also serve as the platform to perform refueling, and replacement or repair of damaged capture bags.

The capture bag may also support commercial opportunities in debris removal. In particular, it may be possible to utilize the capture bag as a payload on the end of the robotic arm on the Northrop Grumman MRV servicing spacecraft in GEO.

### Technical Aspect 5: Space-Qualified Payload

A fifth technical aspect aims to mature the development of a flyable, space-qualified payload by focusing on material selection, mechanisms, sensors, and interfaces with host spacecraft. The technical designs and compatibility with existing systems like Northrop Grumman's MRV can provide broad commercial applications for the capture bag, for example, addressing the ADR needs of NASA.

One important design consideration for the capture bag include space-qualified materials, mechanisms, and sensors. The selection and evaluation of space-qualified materials, mechanisms, and sensors can be desirable for the successful operation of the capture bag in the harsh space environment. The components of the capture bag are selected to withstand the extreme temperatures, radiation, and vacuum conditions in orbit, ensuring the reliability and performance of the capture bag throughout its designed mission life. Numerous materials have been evaluated for use in space applications. These include, metal foils, glass fibers, Kapton, Mylar, and Kevlar. A comprehensive database of space-qualified materials may be found at https://www.spacematdb.com/.

Embodiments of the capture bag may vary based on detailed interface descriptions and constraints from currently different host spacecraft. For example, the interface parameters between the capture bag and potential host spacecraft, such as Northrop Grumman's MRV, may be a design consideration. Ensuring compatibility with MRV's robotic arm provides one example implementation for the capture bag with an existing leader in in-space logistics, increasing the likelihood of adoption in debris removal missions more broadly.

Detailed cost modeling of flight-like payload can also affect the capture bag design. Detailed cost modeling of a flight-like payload at various scales can show the capture bag's feasibility for both NASA and commercial customers, emphasizing its potential as a competitive solution in the debris removal market.

### Mission Risk

Throughout the above set of technical aspects, certain mission risks associated with the various aspects of debris capture using the capture bag have been identified and mitigation plans that inform test plans within the scope of this work or incorporated into further development efforts can be developed. Initial mission risks have been identified in the table below.

Aspects of this disclosure can mitigate technical and programmatic risks associated with the capture bag. This can be achieved through design, fabrication, modeling, and laboratory testing of large capture bag payloads plus continuing detailed cost/benefit modeling and mission studies.

One risk to mitigate is that of debris or other captured object ripping the material used to enclose it (e.g., and enclosure, capture bag, net, etc.) This can be mitigated or addressed in various ways. In embodiments having a containment bag separate from extension structures (e.g., inflatable struts), the bag may not be an integral part of the deployment structure. Therefore, most rips in the bag will have no major effects on the operations of the bag except that it increases the likelihood that very small debris is still able to escape from the sealed bag. Differences in angular rotation rates between debris objects and a capture bag can affect this risk, given that greater differences can increase sheer or other cutting or harmful energy effects. In some embodiments, capture bags can be removable such that they can be disposed of and/or replaced if necessary. Ripstop materials can be used, which may include fiber and weave laminates.

Risks include that a spacecraft may not be able to track a debris object, and this can be relevant whether a capture bag is in an open or closed position. For example, tracking can occur when approaching the object, and tracking can continue even after a capture bag opens. This can be accomplished for example by using some visual or other tracking devices on the outside of an approach vehicle and some on an inside of a capture bag. They can coordinate their views such that an item of debris is consistently tracked. Sensors can be located and configured to avoid interference by the process or structures for opening a bag. Rendezvous and proximity operations hardware, sensors, and software can be used for this process. Debris that is deorbiting can present related risks.

Risks include that captured objects may not be controllable by a spacecraft guidance, navigation and control (GNC) system. This can result from momentum transfer, for example if a captured object has a much higher mass and relative rotational energy when compared to the spacecraft having the GNC. Expected angular momentum change profiles of debris can be developed using testing with mass simulators with variable angular rates imposed by spin tables and gravity offloading. Such expected profiles can help define requirements for host spacecraft systems and mission requirements on the types of debris that are capable of being captured safely by the system. Once a system is stable, cables can retract within the bag to ensure debris is tightly mechanically coupled to the host spacecraft to ensure predictable dynamics during slewing and maneuvering. Modeling was performed and compared to JPL Asteroid Redirect Mission (ARM) studies showing feasibility of control of 500 ton masses.

Risks include that the item being targeted (e.g., a micrometeoroid and orbital debris or MMOD) damages capture bag inflatable struts, for example. Embodiments having a containment bag separate from extension structures (e.g., inflatable struts) can mitigate risk of damage to the integrity of the enclosure such that debris can be contained despite some damage. In some embodiments, the entire capture bag payload can be detachable, disposed of, and replaced if necessary. Some embodiments use minimal inflation pressure to fully deploy the bag. In such cases, leak rates even for moderate sized holes are very small. Leaks for such a design would not prevent the continued use of the capture bag, but would solely result in reduce total number of inflations/reuses (i.e. graceful degradation). Multi-wall and redundant strut designs may also be used to mitigate such risks.

It is useful to construct detailed engineering models of the capture bag using CAD, enabling kinematic studies of bag deployment and capture. Comprehensive analysis and simulation can include structural and vibrational analysis of deployment and capture, as well as assessing the impact of captured debris on the bag material and the effects of robotic arm deployment. Design of a flight-like payload can involve identifying space-qualified materials, flight sensors, mechanisms, and actuators, defining the interface to the host spacecraft, and providing a cost assessment for the flight payload.

Managing rotational dynamics can be assessed through the creation of a detailed engineering model, kinematic studies, and analysis of the bag's deployment and capture. Capture bag scalability can be directly addressed through the determination of prototype structure, support materials, and optimized bag size. Multiple target constraint is tackled through the trade study for constraining multiple objects and the design of an initial concept. A flyable, space-qualified payload is addressed by identifying space-qualified materials, flight sensors, mechanisms, actuators, and defining the interface to the host spacecraft, as well as assessing the costs associated with the flight payload.

### Prototyping and Fabrication of Large Capture Bag

Technical Aspect 3 focuses on the prototyping and fabrication of scaled-up capture bags to be used in lab testing. This involves multiple cycles of agile prototyping methods to rapidly develop and test components of the capture bag, including processing of soft goods into inflatable struts, additive manufacturing of joints and interfaces, and deployment functionality tests to evaluate and refine the design.

The technical aspect also includes the fabrication and assembly of the test capture bag, which entails manufacturing the designed parts, procuring commercial off-the-shelf (COTS) components, and carrying out the build and assembly process. Multiple deployment and static tests can be performed to ensure the basic functionality meets the parameters set forth in the design phase.

Technical aspect 3 addresses key aspects of Technical aspects 2 and 5. Technical aspect 2 (capture bag scalability) is addressed by the agile prototyping and additive manufactured scale section build, allowing for the testing and optimization of various bag sizes and configurations. Technical aspect 5 (flyable, space-qualified payload) is addressed through the material selection and component testing performed in this work area.

Technical aspect 4 involves the testing of the large capture bag system, particularly to constrain the capabilities of capturing tumbling objects. This involves first designing the deployment experiment and setting up the demonstration, which includes procuring and fabricating testbed hardware. The testbed involves placing the large capture bag on a spin table that can simulate the rotations of the host spacecraft. Mass simulators representing scale models of spacecraft and rocket bodies can be suspended from a gantry and given angular momentum (either through another spin table to simulate additional inertia or simply by spinning them on a bearing). Limits on relative rotation rates can be further developed using different methods of angular momentum control. Stability and predictability of capture bag dynamics during capture inform capture procedure and design refinements for future bag designs. Execution of these tests can evaluate the system's ability to effectively manage rotational dynamics and secure debris in a realistic scenario.

Additionally, multiple object capture testing can be performed to assess the system's capacity to confine multiple targets within a single bag without generating incidental debris. Tests as described above can also be performed with existing debris already constrained within the bag to investigate the feasibility, procedures, and dynamics of capturing multiple pieces of debris. Throughout the testing process, data can be recorded, documented, and reported to ensure accurate analysis and validation of the capture bag's performance.

Technical aspect 4 provides the experimental demonstration and validation of Technical aspects 1, 2 and 3. This can test the performance of the large capture bag in constraining large rotating and tumbling mass simulators. It provides demonstration of the design of scaled-up capture bag and the fabrication processes. And the testing demonstrates the feasibility of capturing multiple objects within the same capture bag.

The capture bag designed for testing can be scaled such that the deployed system and ground support equipment are the maximum scale feasible in our lab space (approximately ~5 m tall capture bag).

Technical aspect 5 includes mission analysis and the development of a commercialization plan for the Apis capture bag. The mission analysis aspect of the technical aspect involves Δv modeling for proximity operations, debris-to-debris transfer, and deorbit trajectory optimization. These analyses help refine the system architecture based on testing results and contribute to a better understanding of the market projection and the refinement of the targets that are suitable for removal using the capture bag.

The commercialization planning portion of the technical aspect entails developing a timeline for taking the system to market, as well as creating a comprehensive business model. This includes the development of a mitigation plan for potential business risks and determining the current and future capitalization or funding support needed for the project's success.

Technical aspect 5 addresses Technical aspect 4, which pertains to architectural modeling, mission design, and cost/benefit analyses. The mission analysis and architecture study refinement aspects of this technical aspect incorporate the results of the experimentation performed in Technical aspect Area 4.

### Phase 2 Implementation Risks

Risk 1: Inflatable strut mechanical stability and structural integrity during dynamic loading. The current design of the inflatable members uses adhesives, joints, and bonding that may not be well suited for significantly larger structures or for space-qualified structures, particularly when large dynamic loads are applied when capturing tumbling mass simulators. Preventing buckling of large scale structures during capture of large objects may require scaling boom members to larger diameters than modeled, increasing mass of the system and inflatant gas. These risks can be mitigated through early risk reduction testing in the task plan to, first, investigate large scale inflatable tube materials and structures. Building prototypes of large scale joint and single beams can help verify that they are sufficient for the large-scale capture bag prototype applications and testing.

Risk 2: Scaled testbed to fit in the laboratory provides insufficient fidelity to accurately demonstrate capture dynamics. The largest debris targets-and a capture bag sufficiently large to capture those targets-may not fit in some laboratories. Therefore a smaller scale (but still quite large) capture bag can be used with representative scaled mass simulators of rocket bodies and other large spacecraft targets. Relative angular momentum and inertia can be used to simulate accurate dynamics of scaled-up captures, however there may be some effects that scale in unpredictable ways that aren't fully captured by a lab-scale demonstration. The primary mitigation involves creating accurate simulations that are validated by our laboratory demonstrations at multiple scales, and then using the simulations to extrapolate beyond the scales currently achievable in our lab.

Risk 3: Insufficient data about the states of targets. In order to select the most effective size and aspect ratio of a commercializable capture bag, accurate data can be obtained as to the sizes, orbits, and—perhaps most importantly—the rotation states of potential targets. During the final months, Phase 1 Ignite can involve tightly investigating and constraining the rotational states of the top potential targets for removal. This informs the aspect ratio of the capture bag that we build as the lab prototype in the Phase 2. Currently, CAD models show slightly elongated capture bags that are most suited to objects that are rotating at very slow rates about their long axis (such as a spacecraft that is not tumbling, or has aligned its solar arrays along the gravity gradient). Recently launched rocket bodies may be more likely to be tumbling in a “flat spin”. These pieces of debris can be targeted using a capture bag that is shorter in length, but with a larger opening diameter. Simple dynamical simulations help mitigate this risk.

Risk 4: Insufficient schedule allocated to fabrication of soft goods, test bed, or other hardware. Fabrication of seamless, airtight soft goods is a time and labor intensive process. Soft goods have been used in previous capture bag work to investigate large inflatable towers at the lunar poles for power generation. However, the large scale capture bag for this disclosure may involve additional time to ensure reliability and robustness. This risk is mitigated by initial tests of small scale portions of representatively sized portions of the final structure. The assembly of these components are more representative of the time required to fabricate the final system, compared to estimations based on previous inflatables.

### Related Research and Development

Supporting projects and research include: Deployment of the initial prototype capture bag by inflation of deployment and spreader struts; Capturing a simulated asteroid (0.5 m spherical balloon) by deflation of spreader struts and inflation of closing struts; Closure of the capture bag by Zipperbot (e.g., provided by The YKK Fastening Products Group); Clinching of the capture bag by deflation of deployment struts and reeling of pull-down straps to position the simulated asteroid for mining; Opening of capture bag deflation of closing struts, inflation of spreader struts, and unzipping of capture bag by Zipperbot; Re-deployment of the capture bag by inflation of deployment struts to release simulated asteroid in preparation for recapture of same asteroid or capture of new asteroid.

The initial bag concept is derived from the work done for the Asteroid Redirect Mission (ARM), a NASA mission that would have captured a <8 m asteroid in an inflatable capture bag and brought it back to a distant retrograde lunar orbit for astronauts to visit. The mission concept was first adjusted to instead, use a robotic claw to pull a boulder off a much larger known asteroid to avoid the uncertainty of rendezvous with a small, previously unvisited asteroid. Subsequently, the entire ARM mission was canceled in 2017. However, work for the capture bag concept performed at the time is directly applicable to the described capture bag and feeds directly into TransAstra's development. The concept for an asteroid retrieval mission has been studied in detail.

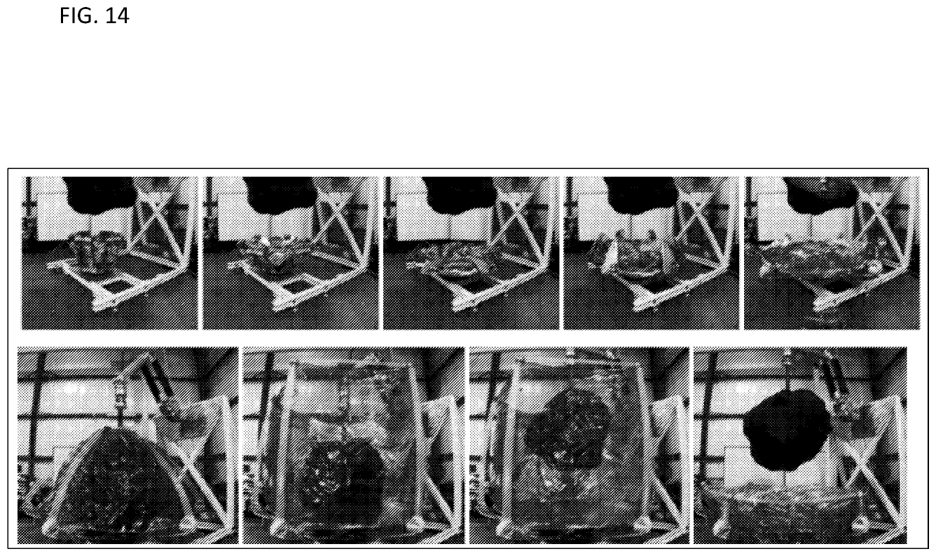

FIG. 14 shows an image of a testbed at JPL for capture bag concepts from the Asteroid Redirect Mission (ARM). The testbed used for aspects of this disclosure draws from the design and lessons learned associated with this earlier effort. The described capture bag can be used as an end effector on a robotic arm in order to interface with spacecraft of various shapes as shown in the figure above. Some sizes of the capture bag can be suitable for launch on a Northrop Grumman ESPAStar platform, can be delivered to GEO to be retrieved by an MRV, and then can be stashed on the same interface on which the MRV stores MEPs. The described devices can provide debris clean up services in LEO, GEO, or elsewhere.

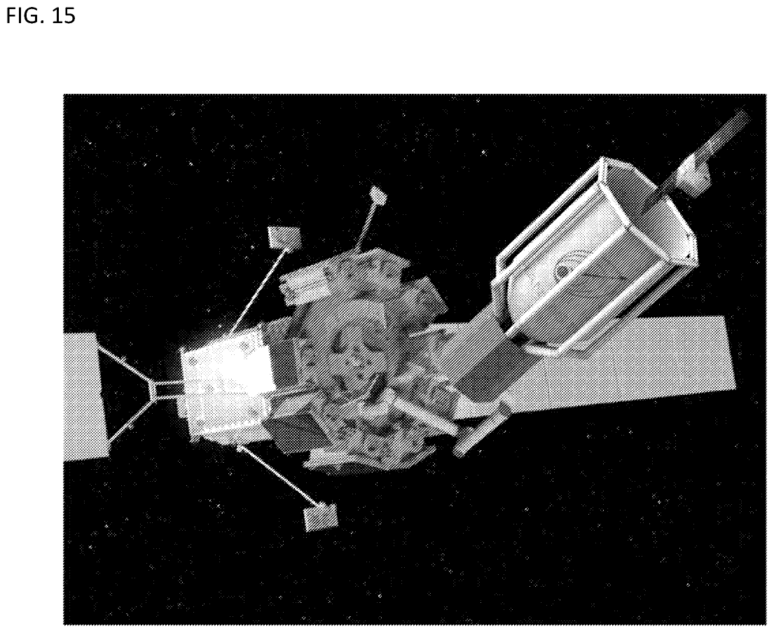

FIG. 15 shows an embodiment of the capture bag being used as an end effector for the Northrop Grumman MRV in accordance with aspects of this disclosure. In this application the bag is stowed on the payload deck using grapple fixtures with the same form factor and interfaces as the mission extension pods (MEPs). Capture bag allows for MRV to capture small GEO debris and move it to a graveyard orbit.

Various other commercial organizations have also proposed either debris capture mechanisms or architectures for debris removal services.

The described capture bag technology offers a more versatile and scalable solution that addresses the limitations of existing debris removal concepts while minimizing the risk of generating additional debris.

### Additional Examples

Certain capture bag disclosures were designed for capture of water and other volatiles from asteroid mining. Mylar bags used in such systems were designed to be vapor tight at the reduced pressures expected in space operations. They included a pressure-tight zipper and an electrically powered zipper bot to close the bag after asteroid capture.

When extending the disclosed capture bag concept to capture of space debris, vapor tight containment may not be necessary. Since it is not necessary to intentionally heat the captured objects, outgassing is not likely. Even if the captured objects do outgas due to handling, the gas may not be a space hazard and can be safely let go. It may be desirable to contain objects such as loose nuts and bolts, shards of broken solar panels and generally particles larger than a paint chip. Such objects can present dangers to space travel, such as the errant paint chip in orbit that was said to ding the windshield of one of the space shuttles.

Capture bag materials can be generalized beyond mylar films to porous fabrics of more or less tight weaves. Coarse nets can also be used. Zipper closures can be used, or may be replaced or supplemented by simple draw strings or other closures.

Nets can be used within the Capture Bag for capture and control of space objects. It may be desirable to use a spray-on expanding foam as a method to accelerate the natural deorbit of space junk. A large foam ball can be used to engulf the target debris and increase the aerodynamic drag of otherwise small objects. That can cause the small objects to naturally deorbit years sooner.

In some embodiments, the capture bag can have multiple independent liners. Referring back to FIGS. 2A-2F provide an example embodiment of the capture bag 200. The first captured object 202 is wrapped and contained in the first liner 206. The liner 206 may then be contracted and pulled toward a wall 212 of the capture bag 200 to make room for additional captured objects 204.

In some embodiments as shown in the embodiment of FIGS. 3A-3G, initially, foam 308 can be sprayed on incoming debris before bagging. This can help to confine any small loose pieces. Foam 308 also smooths the object, making it less likely to damage the capture bag 200 if the capture bag 200 closes on rotating objects with sharp corners.

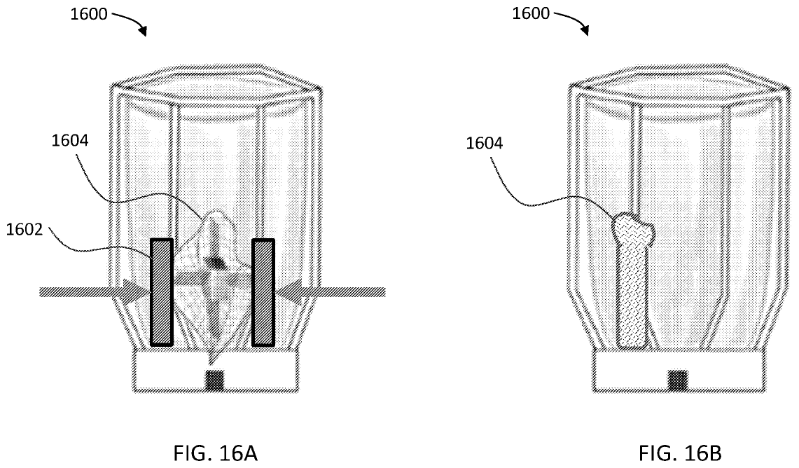

In yet another embodiment, the capture bag is provided with a trash compactor to make room for additional captured objects. FIGS. 16A and 16B illustrate an embodiment of the capture bag 1600 including a trash compacter 1602 in accordance with aspects of this disclosure. FIG. 16A shows the trash compacter 1602 compacting a target 1604 and FIG. 16B shows the target 1604 after being compacted by the trash compacter 1602.

In certain embodiments, following the capture of a load of objects, a worker bee space tug can deliver the collected trash to an orbital recycling station. Alternately, the worker bee can change (decrease) the orbital velocity of the capture bag to insure rapid re-entry. The worker bee then detaches from the collection bag and climbs back up to a higher orbit and likely rendezvous with a refueling station.

In some embodiments, the ConOps for multiple debris capture using multi-layer net concept can include, in phase 1, opening the capture bag to be ready to capture a target. In phase 2, a first target is captured within a first layer of flexible nets. Phase 3 involves sealing the main bag and the first layered net is reeled in towards the base of the system to contain the target.

The ConOps can continue with phase 4, in which a next target is identified and the capture bag is opened and prepared. In phase 5, the next target is captured within the second layered net. Phase 6 can involve repeating phase 3 including sealing the main bag and reeling in the second layered net towards the base of the system to contain the next target. This process can be repeated based on the size of the capture bag and the number of layered nets the capture bag is lined with.

In some embodiments, the ConOps for multiple debris capture using foam spray can include, in phase 1, opening the capture bag to be ready to capture a target. In phase 2, foam nozzles are used to spray the sticky, non-brittle foam onto the target. Phase 3 involves the foam sticking to the target and expanding as the target enters the bag. At phase 4, the first target is captured and the capture bag closes. In phase 5, a next target is identified and the capture bags is opened. The nozzles spray the second target with foam. Phase 6 can involve repeating phases 2 and 3, including spraying the foam onto the next target with the foam sticking to the target and expanding as the target enters the bag. This process can be repeated based on the size of the capture bag and the amount of foam stored.

### Example Capture Bag Embodiments

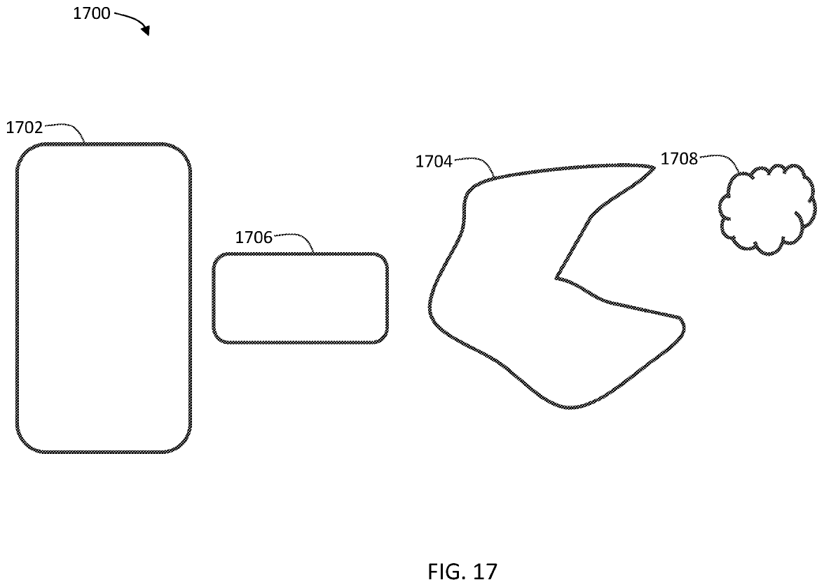

FIG. 17 is a block diagram illustrating an embodiment of a system 1700 for capture of space debris in accordance with aspects of this disclosure. As shown in FIG. 17, the system 1700 includes a proximity engine 1702, a surrounding material 1704, and an extension device 1706. The proximity engine 1702 is configured to locate the system within an operable distance of space debris 1708. The surrounding material 1704 is configured to at least partially enclose the space debris 1708. The material may have sufficient resilience to reduce rotational energy and resist ripping. The extension device 1706 is configured to move the surrounding material 1704 through the operable distance such that the surrounding material 1704 at least partially encloses and thereby captures the space debris 1708.

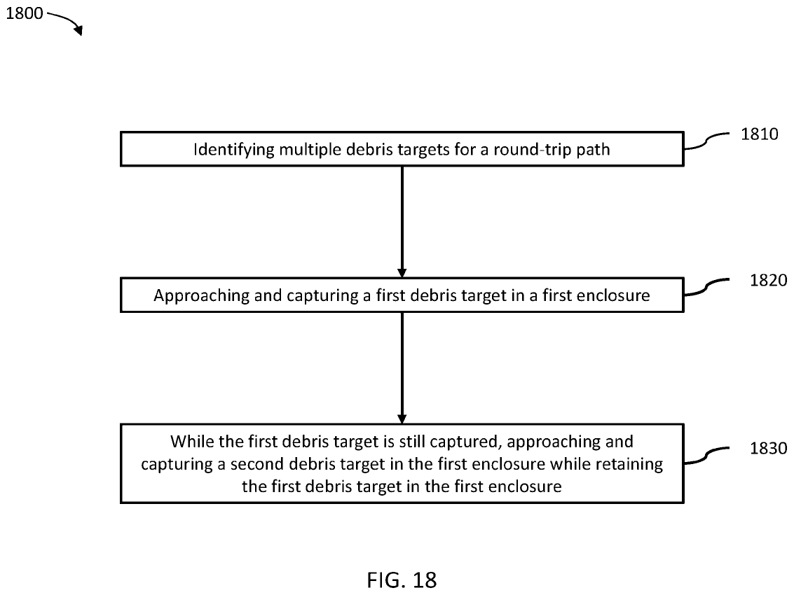

FIG. 18 is a flowchart of an example method 1800 for reducing propellant for space debris capture missions.

At step 1810, the method 1800 involves identifying multiple debris targets for a round-trip path.

At step 1820, the method 1800 involves approaching and capturing a first debris target in a first enclosure.

At step 1830, the method 1800 involves, while the first debris target is still captured, approaching and capturing a second debris target in the first enclosure while retaining the first debris target in the first enclosure.

In some embodiments, the method 1800 can further include retaining the first debris target in the first enclosure using a non-rigid retention material configured to surround the first debris target and a tether configured to link the non-rigid retention material to an interior side of the first enclosure.

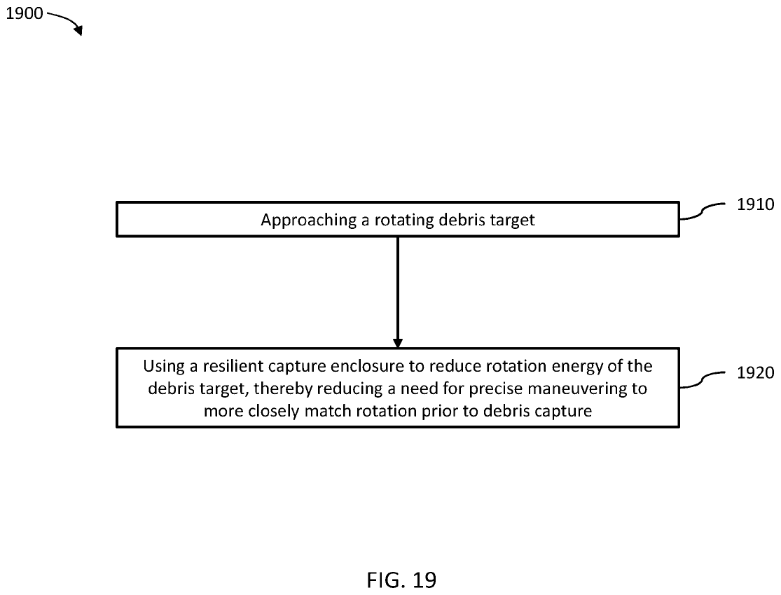

FIG. 19 is a flowchart of an example method 1900 for reducing propellant for space debris capture missions.

At step 1910, the method 1900 involves approaching a rotating debris target.

At step 1920, the method 1900 involves using a resilient capture enclosure to reduce rotation energy of the debris target, thereby reducing a need for precise maneuvering to more closely match rotation prior to debris capture.

In some embodiments, the method 1900 can further include reducing rotation energy of the debris target after capture using a maneuvering system.

### Example Capture Bag Embodiments

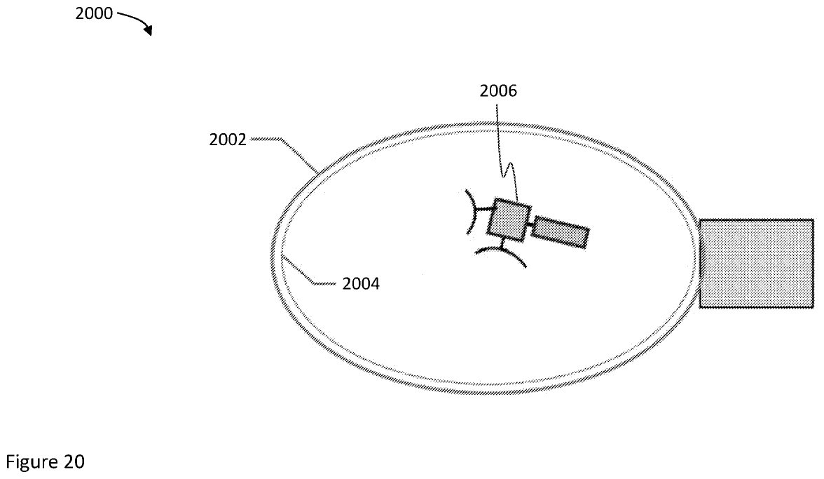

FIG. 20 is a diagram illustrating an embodiment of a capture bag 2000 for capturing space debris in accordance with aspects of this disclosure. As shown in FIG. 20, the capture bag 2000 includes a faraday cage forming one or more outer layers 2002 and at least one ferrite absorber layer(s) 2004 formed on an interior of the one or more outer layers 2002. The one or more outer layers 2002 are configured to block outgoing signals from the capture bag 2000. The ferrite absorber layer(s) 2004 is configured to minimize radiation leaks from the capture bag 2000. Together, the one or more outer layers 2002 and ferrite absorber layer(s) 2004 can be configured to block radiation and outgoing signals to attenuate RF signals from any debris 2006 captured by the capture bag 2000.

In some embodiments, at least some of the bag material (e.g., the one or more outer layers 2002) can be chosen to act as a shield for electromagnetic radiation, thereby forming a Faraday shield. The Faraday shield can be configured to prevent outside radiation or signals from reaching a captured object/debris 2006 and/or to prevent radiation from a captured object/debris 2006 from interfering with activities outside of the capture bag 2000. The Faraday shield may be designed to block any or all of the following fields, including: electrostatic, radio frequency and microwave, infrared, visible, and/or ultraviolet radiations.

In some embodiments, the capture bag 2000 can have the ferrite absorber layer(s) 2004 configured to absorb radiation which may be emitted from the captured object/debris 2006 to enhance the shielding capabilities of the Faraday shield formed by the one or more outer layers 2002.

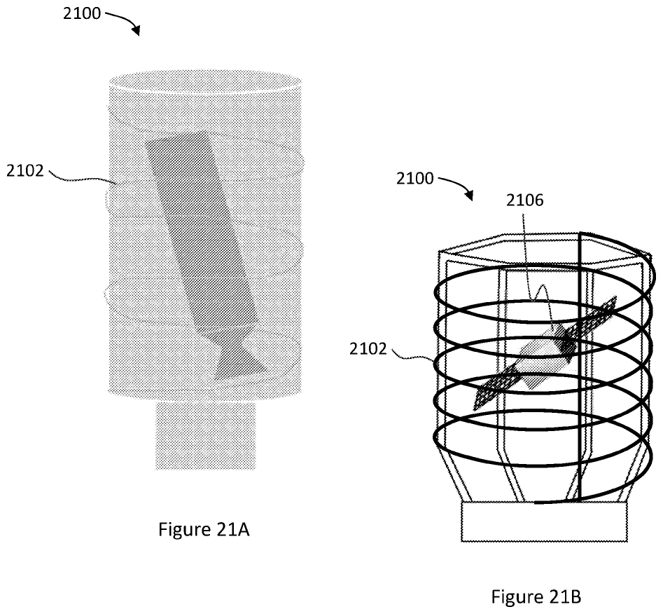

FIGS. 21A and 21B are two views illustrating an embodiment of a capture bag 2100 for capturing space debris in accordance with aspects of this disclosure. As shown in FIGS. 21A and 21B, the capture bag 2100 includes a plurality of current loops 2102. Also shown is debris 2106 contained within the capture bag 2100. The current loops 2102 are configured to induce magnetic torque to provide magnetorque control. The plurality of current loops 2102 are electrically conductive and can be incorporated into the capture bag 2100 fabric. When supplied with electrical current, the plurality of current loops 2102 can generate a solenoidal magnetic field to act against external magnetic fields, such as nearby Earth's magnetic field, resulting in applying mechanical torques to the spacecraft to which the capture bag 2100 is coupled.

In some embodiments, the plurality of current loops 2102 can be used to cause the spacecraft to change its pointing direction without needing to expend rocket propellant. The plurality of current loops 2102 can be effective in producing torque in proportion to the current supplied to the main bag 210 and the area or volume enclosed by the plurality of current loops 2102. Thus, deploying the capture bag 2100 to its maximum size can increase the torque on the spacecraft compared to smaller loops that could be mounted on or around the spacecraft.

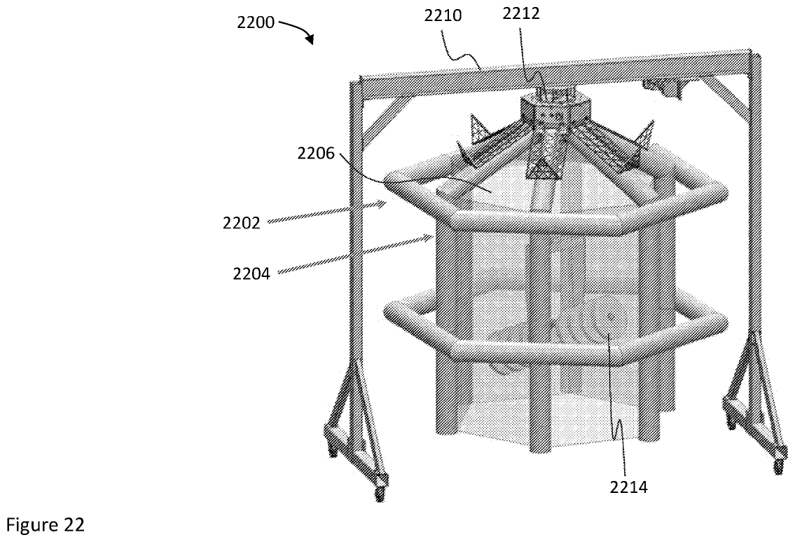

FIG. 22 is a diagram illustrating an embodiment of a capture bag 2200 for capturing space debris in accordance with aspects of this disclosure. As shown in FIG. 22, the capture bag 2200 includes a plurality of inflatable ribs 2202 and a plurality of inflatable struts 2204. The plurality of inflatable ribs 2202 and the plurality of inflatable struts 2204 can be connected to the main bag 2206 of the capture bag 2200.

FIG. 22 also illustrates the capture bag 2200 on a testbed configuration with a spin table 2210 having a spin table 2212 and a suspended target simulator 2214.

In some embodiments, a final deployed shape of the main bag 2206 is determined by controlled inflation of a plurality of deployment tubes including the plurality of inflatable ribs 2202 and the plurality of inflatable struts 2204. The plurality of inflatable ribs 2202 and the plurality of inflatable struts 2204 can be attached to the main bag 2206 at several attachment points on the outside of the main bag 2206.

In some embodiments, the deployed shape of the main bag 2206 can be changed and/or adjusted to close and capture space objects by selectively inflating the plurality of inflatable ribs 2202 and the plurality of inflatable struts 2204.

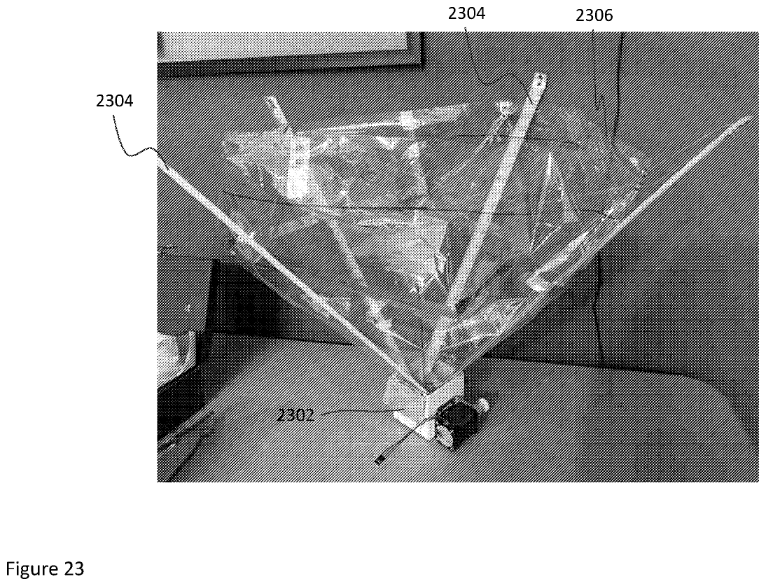

FIG. 23 is a diagram illustrating an embodiment of a capture bag 2300 for capturing space debris in accordance with aspects of this disclosure. As shown in FIG. 23, the capture bag 2300 includes a deployment system 2302 including a plurality of pretensioned tape springs 2304 configured to deploy the main bag 2306.

In some embodiments, the deployment system 2302 is configured to release the plurality of pretensioned tape springs 2304 from a stowed configuration (e.g., within the deployment system 2302) in order to unfold the main bag 2306.

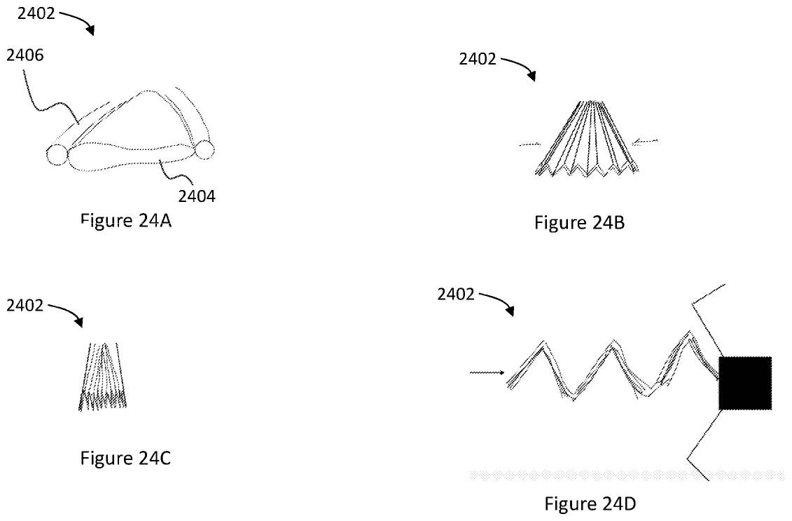

FIGS. 24A-24D are diagrams illustrating an embodiment of a method for deploying a capture bag 2402 for capturing space debris in accordance with aspects of this disclosure. As shown in FIG. 24A, the capture bag 2402 can include a bag membrane 2404 and a plurality of flexural inflatable tubes 2406 supporting the bag membrane 2404 prior to folding.

In FIG. 24B, the bag membrane 2404 and the plurality of flexural inflatable tubes 2406 are folded using a z-folding method until being compressed together as shown in FIG. 24C. The bag membrane 2404 and plurality of flexural inflatable tubes 2406 can then be stowed into a housing 2408 as shown in FIG. 24D.

In some embodiments, the capture bag 2402 (including the bag membrane 2404) and plurality of flexural inflatable tubes 2406 can be folded to a stowed configuration using a z-folding.

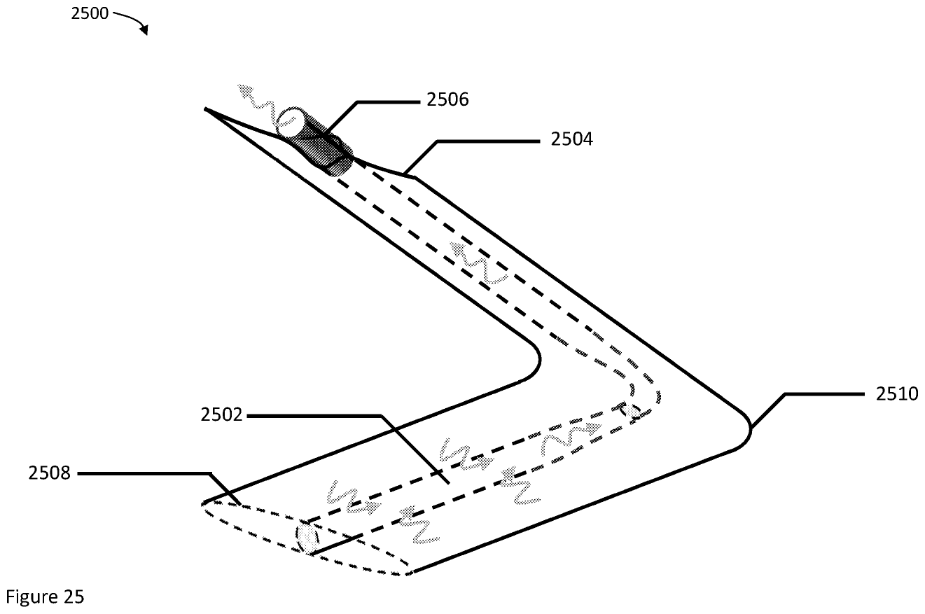

FIG. 25 is a diagram illustrating an embodiment of a deployment tube 2500 which can be used, for example, as a deployment strut a capture bag in accordance with aspects of this disclosure. As shown in FIG. 25, the deployment tube 2500 includes a porous tube 2502 and an end cap 2504 coupled to a computer controlled exhaust port 2506. Also shown is a cross-section 2508 of the deployment tube 2500. The deployment tube 2500 can be folded into a z-fold 2510 configuration.

In some embodiments, a capture bag can include one or more flexible deployment tubes 2500, each having an internal porous tube 2502 with a controlled gas discharge port 2506 (e.g., computer-controlled). The port 2506 can be configured to vent unintentionally trapped gasses into the vacuum of space before the capture bag is released for controlled inflation. For example, a small amount of residual gas may have been trapped on Earth in the folds of the deployment tube 2500. This trapped gas can cause uncontrolled and nearly explosive expansion of the entire structure if released from physical containment into a vacuum environment. Thus, the porous tube 2502 can vent any trapped gas to space before mechanically releasing the z-folded configuration, thereby preventing such explosive inflation.

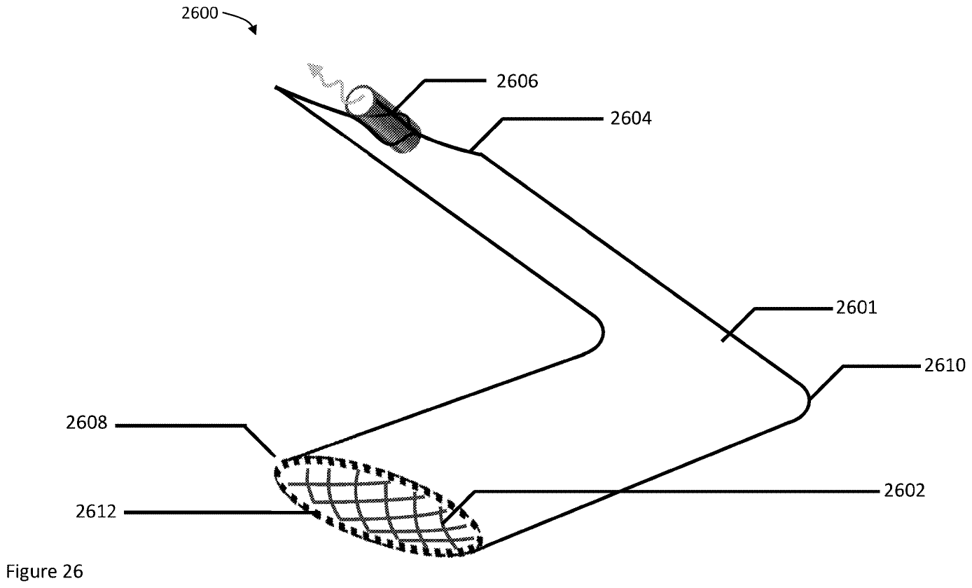

FIG. 26 is a diagram illustrating an embodiment of a deployment tube 2600 which can be used, for example, as a deployment strut a capture bag in accordance with aspects of this disclosure. As shown in FIG. 26, the deployment tube 2600 can include a woven fabric mesh 2602. The deployment tube 2600 can be constructed of a membrane 2601 that is gas-tight and is bonded to the woven fabric mesh 2602. The deployment tube 2600 can also include an end cap 2604 coupled to a computer controlled exhaust port 2606. Also shown is a cross-section 2608 of the deployment tube 2600 with a porous liner 2612. The deployment tube 2600 can be folded into a z-fold 2610 configuration.

In some embodiments, a capture bag can include a plurality of deployment tubes 2600 constructed from a gas-tight membrane 2601 that has been bonded to an internal fabric liner 2602 including loosely meshed fibers. The fiber mesh can be configured to vent unintentionally trapped gases into the vacuum of space via the computer controlled exhaust port 2606 before the capture bag is released for controlled inflation. This process may be similar to the venting of trapped gases described in connection with FIG. 25.

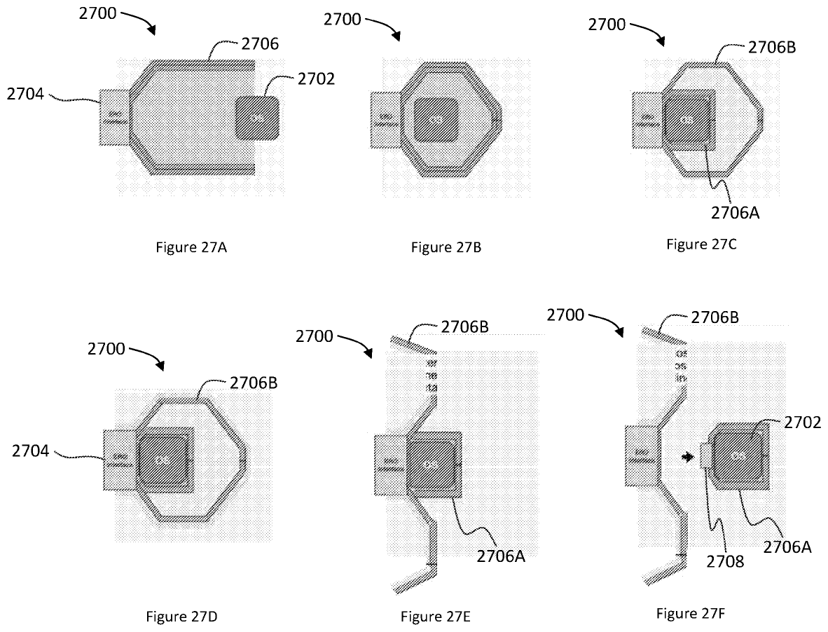

FIGS. 27A-27F illustrate an example with schematics of a Mars sample capture phase utilizing a double-layer capture bag to maintain clean zones, free from Mars dust contamination. The possibly-contaminated Mars surface samples can be engulphed and retrieved by a double capture bag (e.g., from a low-altitude transfer orbit near Mars). The samples can be delivered to a transfer orbit near Earth. The delivered samples can be contained within a single capture bag whose external surfaces are sterile.

In FIG. 27A, a spacecraft can position the capture bag 2700 around an orbit sample 2702 in containment low Mars orbit. The capture bag 2700 can include an Earth return orbiter (ERO) interface 2704 configured to couple the capture bag 2700 to the spacecraft. The capture bag 2700 further includes a main bag 2706 which can include a plurality of layers 2706A, 2706B. As shown in FIG. 27B, the main bag 2706 can be sealed around the orbit sample 2702. As shown in FIG. 27C, an internal layer 2706A of the main bag 2706 can be enclosed around the orbit sample 2702 to form a clean, interstitial space between layers 2706A, 2706B of the main bag 2706.

In FIG. 27D, the spacecraft can return to clean cislunar space. The outer layers of the capture bag 2700 and main bag 2706 may have been contaminated from low Mars orbit. As shown in FIG. 27E, the out layer 2706B of the main bag 2706 can be unfolded. In FIG. 27F, the orbit sample 2702 enclosed in the inner layer 2706A of the main bag 2706 can be deposited in a cislunar holding orbit with a beacon 2708.

The process illustrated in FIGS. 27A-27F can be advantageous by enclosing the orbit sample 2702 in a sealed environment to prevent the possible introduction of harmful contaminants, such as viruses, into the Earth's ecosystem. This may be required by international consensus and by NASA directive.

By collecting samples using the systems and methods illustrated in FIGS. 27A-27F, samples can be collected from a parking orbit around Mars and delivered to a cis-lunar near Earth orbit. The samples will be delivered in a sealed capture bag that has little or no possibility for its external surfaces to be contaminated with Mars germs.

In some embodiments, the main bag contains first and second bags, wherein the second bag can be closed and sealed independently of the first bag.

In some embodiments, the second bag may be an inner bag configured to capture, enclose, and hermetically seal a possibly contaminated space object. Simultaneously the outer bag encloses the sealed inner bag to prevent possible contamination of the outer surface of the inner bag.

In some embodiments, the capture bag releases the inner hermetically sealed bag to a transfer vehicle for a controlled reentry to the atmosphere of Earth. The remaining outer capture bag and its associated spacecraft can be sterilized and destroyed by an uncontrolled high-temperature entry to the atmosphere of earth.

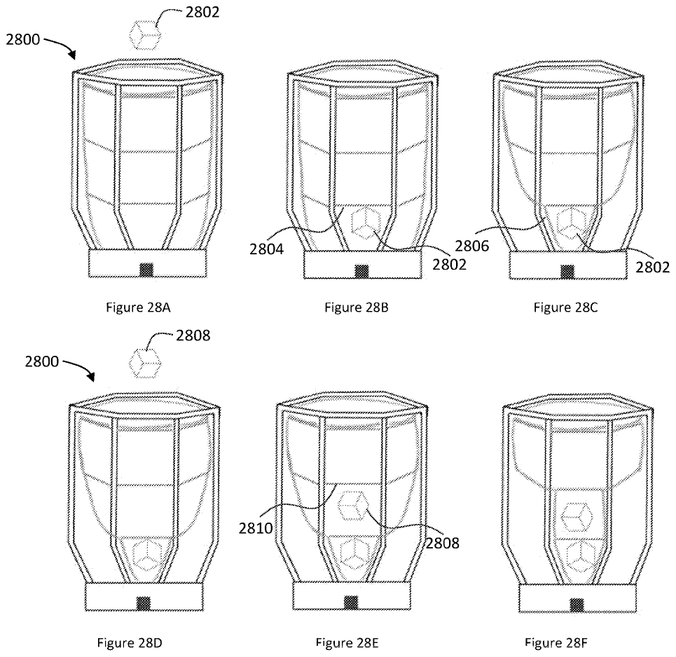

FIGS. 28A-28F illustrate another system and method for capturing multiple objects/debris in accordance with aspects of this disclosure. In FIG. 28A, a deployed capture bag system 2800 approaches a first target 2802 (e.g., a CubeSat). In FIG. 28B, the first target 2802 is captured in a first chamber 2804 in the deployed capture bag system 2800. In FIG. 28C a drawstring 2806 that partitions first chamber 2804 cinches to close off the first chamber 2804 and contain the first target 2802.

In FIG. 28D, the capture bag 2800 opens and prepares for a second target 2808 capture. In FIG. 28E, the second target 2808 is captured in a second chamber 2810. In FIG. 28F, the drawstring 2806 that partitions the second chamber 2810 cinches to close off the second chamber 2810 and contain the second target 2808. This process can be repeated for any number of chambers the 2800 has.

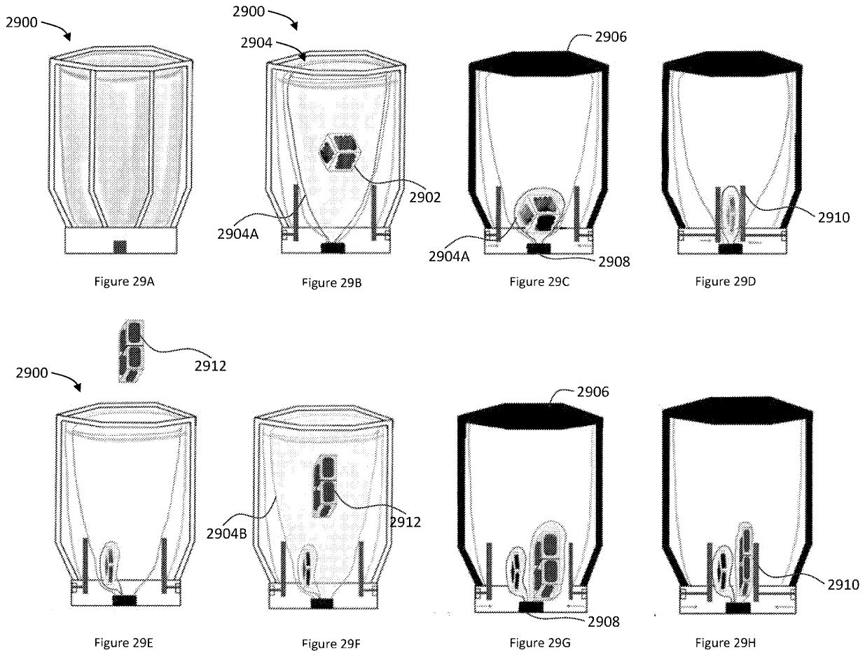

FIGS. 29A-29H illustrate another system and method for capturing multiple objects/debris in accordance with aspects of this disclosure. In FIG. 29A, FIG. 16 the capture bag 2900 is open and ready to capture a first target 2902 (shown in FIG. 29B). In FIG. 29B, the first target 2902 is captured in a first layer 2904A of lightweight bags 2904. In FIG. 29C, a main bag 2906 closes and the first layered bag 2904A is reeled into base 2908 of the capture bag 2900 system to contain the first target 2902. The capture bag 2900 also includes compactor plates 2910 configured to compress inwards towards the first target 2902. The first target 2902 is then compressed by the plates of the compactor plates 2910.

In FIG. 29E, the capture bag 2900 opens and prepares for capturing a second target 2912. As shown in FIG. 29F, the second target 2912 can be captured in the second layer 2904B of the lightweight bags 2904. In FIG. 29G, the main bag 2906 closes and the second bag 2904B is reeled in as close as possible to the base 2908 of the system. In FIG. 29H, the compactor plates of the compactor plates 2910 are again compressed inwards towards the second target 2912 so that the second target 2912 is compressed by the plates.

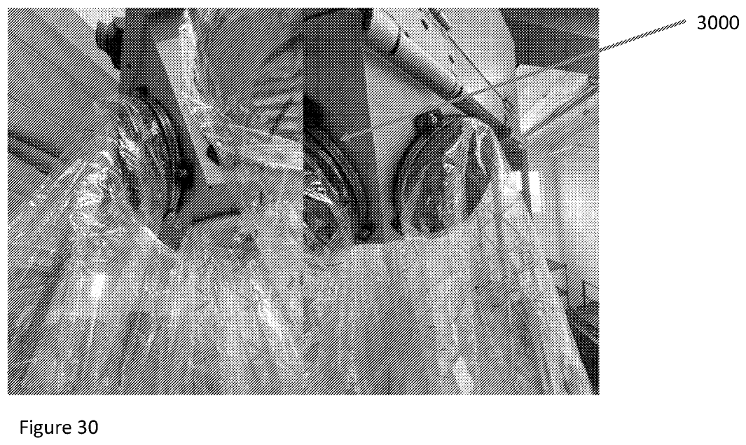

FIG. 30 illustrates an example embodiment of a hose clamp mandrel 3000 which can be used as part of a capture bag in accordance with aspects of this disclosure. The hose clamp mandrel 3000 can be used to secure flexible pressure-tight deployment tubes to a base of the capture bag.

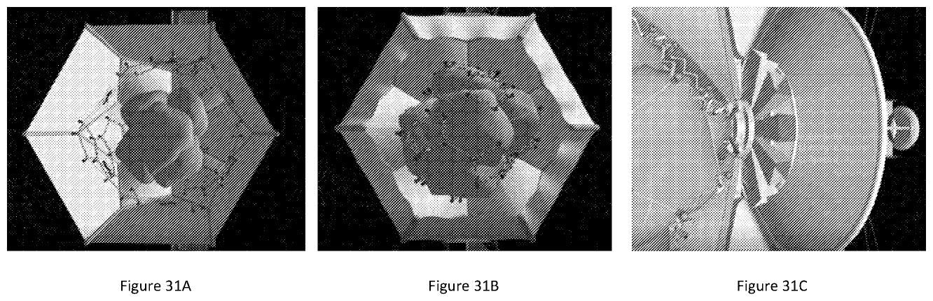

FIGS. 31A-31C illustrate a mechanized collapsible net that is configured to envelope one or more targets and provide hard points for robotic appendages. The mechanized collapsible net can be configured to continues to collapse around a shrinking object.

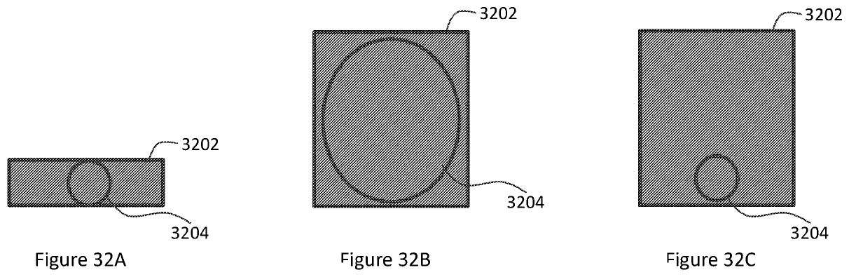

FIGS. 32A-32C illustrate inflatable balloon deployment of bag. In particular, FIG. 32A illustrates a stowed bag 3202 housing a balloon 3204 prior to inflation. In FIG. 32B, the balloon 3204 inflates pushing the bag 3203 outward. In FIG. 32C, the balloon 3204 deflates and the bag 3202 may maintain its shape. In some embodiments, the bag 3202 is made of shape memory alloy to maintain its inflated shape.

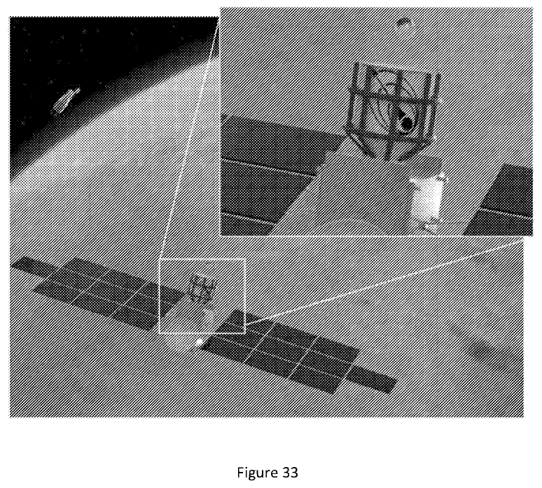

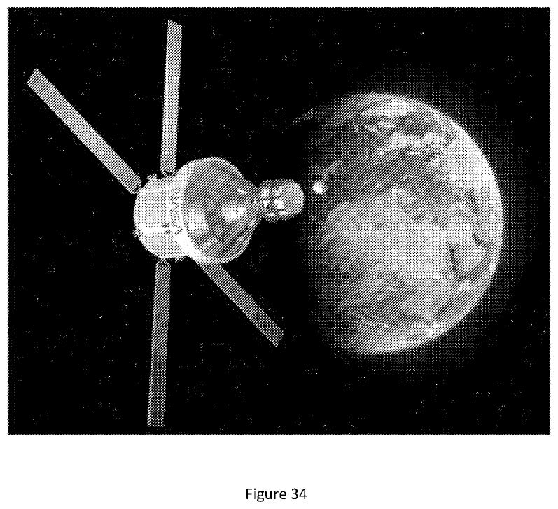

FIG. 33 illustrates an embodiment of the capture bag which can be used to replace JPL's original sample orbiter capture module, an exchange that would greatly simplify mission costs and simplify design requirements for the Earth return orbiter.

FIG. 34 illustrates an embodiment of the capture bag that can be mounted to the exterior of a crewed capsule, such as NASA's Orion Capsule shown above, to perform object captures.

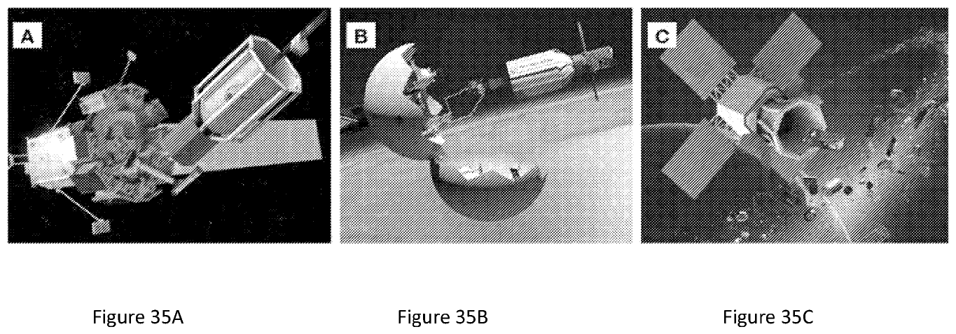

FIGS. 35A-35C illustrate further embodiments of the capture bag in accordance with aspects of this disclosure. FIG. 35A illustrates the capture bag configured to be used as an end-effector on Northrop Grumman MRV to enable servicing and end-of-life repositioning for GEO spacecraft. FIG. 35B illustrates plans for in-space manufacturing platforms and plans to deliver debris to be reused as raw materials for recycling. FIG. 35C illustrates the capture bag scaled to multiple sizes and be hosted as a payload on a variety of commercial spacecraft buses, OTVs, and other logistics vehicles.

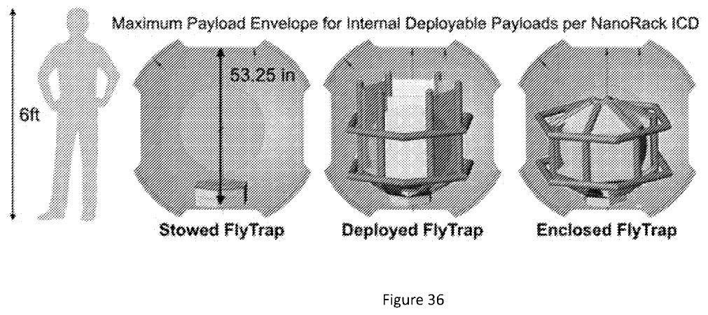

FIG. 36 illustrates an embodiment of the capture bag in stowed, deployed, and enclosed configurations within the Bishop airlock's keep-in envelope for deployable payloads. Also shown is a 6 ft astronaut for scale.

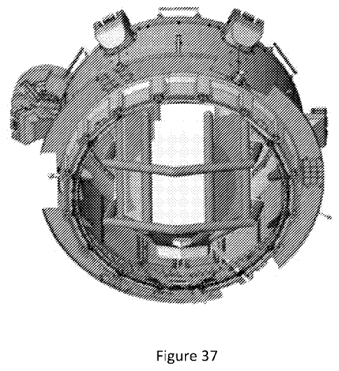

FIG. 37 illustrates another embodiment of the capture bag scaled to fit within Nanoracks' Bishop airlock so that the entire mission can be performed in microgravity and vacuum, without requiring any external hosting.

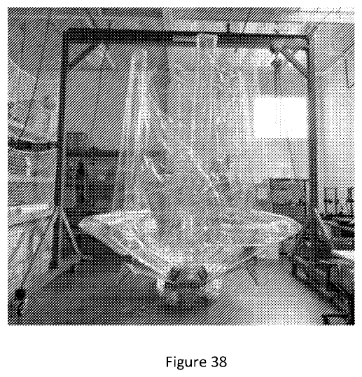

FIG. 38 illustrates yet another embodiment of the capture bag in the form of prototype hardware built for NASA Phase 2 SBIR for debris mitigation applications.

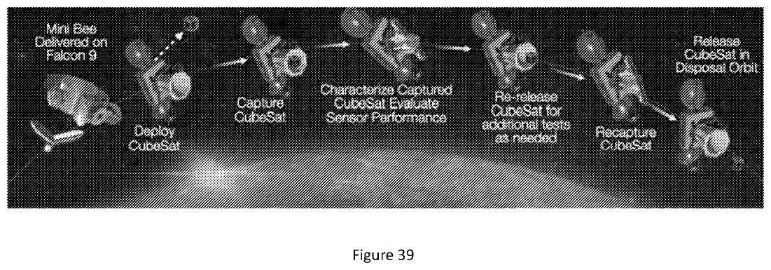

FIG. 39 illustrates an example method for ConOps for a LEO capture bag demonstration on a smallsat bus. This example demonstration mission would validate the capture bag's feasibility on orbit in zero-g.

FIG. 40 illustrates another embodiment of the capture bag in accordance with aspects of this disclosure. As shown, the capture bag is a highly flexible, scalable architecture for many practical applications. Above are concepts for (1) a cubesat demonstration bag, (2) a smallsat class capture bag for capturing cubesats and smallsats, (3) a large capture bag (~5 m) for containing near-Earth asteroids, and (4) a large capture bag for capturing defunct rocket bodies.

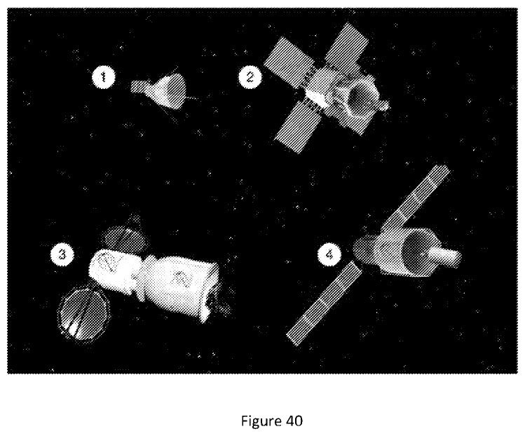

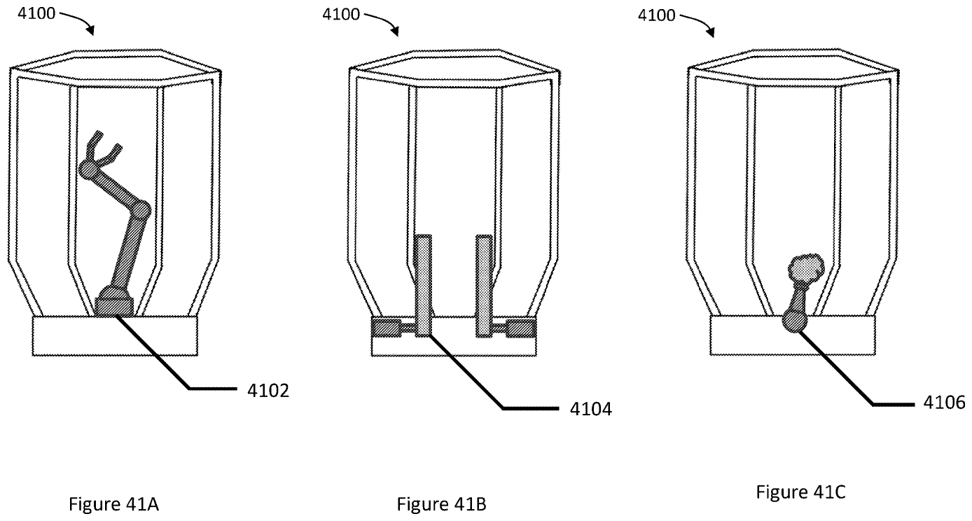

FIGS. 41A-41C illustrate different embodiments of tools that can be included in the capture bag in accordance with aspects of this disclosure. In FIG. 41A, the capture bag 4100 includes a robotic arm 4102. In FIG. 41B, the capture bag 4100 includes two or more compactors plates 4104. In FIG. 41C, the capture bag 4100 includes a foam nozzle 4106.

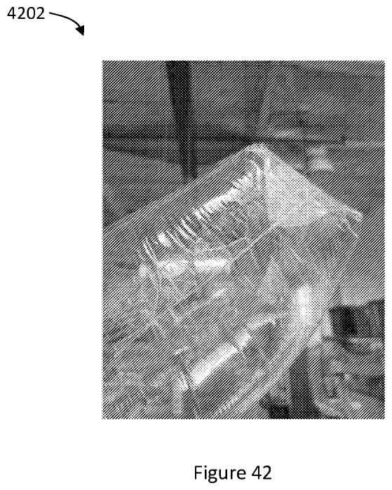

FIG. 42 illustrates an embodiment of an end cap 4202 that can be used for a deployment tube in accordance with aspects of this disclosure. In particular, the end cap 4202 has a fold that creates the end cap 4202 at the end of the flexural inflatable strut (e.g., deployment tube).

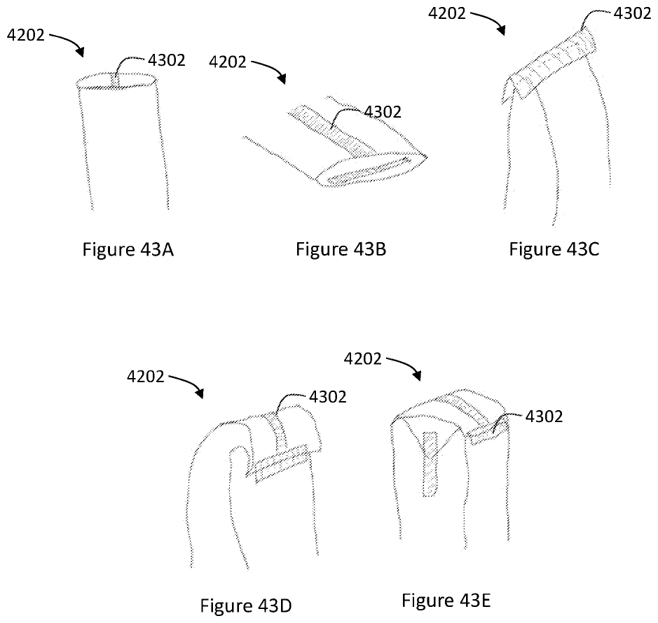

FIGS. 43A-43E illustrate sequential steps for forming an endcap 4202 in accordance with aspects of this disclosure. An adhesive 4302 (such as adhesive tape) can be used to secure the end cap 4202 in certain embodiments.

### Alternatives

Several alternatives of the subject matter described herein are provided below.

Clause 1. A capture bag for capturing space debris, comprising: a main bag configured to open to allow a plurality of target objects to enter the main bag; and a containment system configured to separately contain the plurality of target objects.

Clause 2. The capture bag of Clause 1, wherein the containment system comprises: a plurality of flexible nets arranged in layers within the main bag, wherein each of the flexible nets is configured to contain one or more of the plurality of target objects.

Clause 3. The capture bag of Clause 2, further comprising: at least one cable coupled to the flexible nets; and a motor configured to separately reel in each of the flexible nets using the at least one cable, each of the flexible nets configured to contract onto the one or more of the plurality of target objects when reeled in via the at least one cable.

Clause 4. The capture bag of Clause 2, further comprising: at least one elastic cable coupled to the flexible nets, the at least one elastic cable configured to separately reel in each of the flexible nets, each of the flexible nets configured to contract onto the one or more of the plurality of target objects when reeled in via the at least one elastic cable.

Clause 5. The capture bag of Clause 1, wherein the containment system comprises: a plurality of flexible bags arranged in layers within the main bag, wherein each of the flexible bags is configured to contain one or more of the plurality of target objects.

Clause 6. The capture bag of Clause 5, further comprising: at least one cable coupled to the flexible bags; and a motor configured to separately reel in each of the flexible bags using the at least one cable, each of the flexible bags configured to contract onto the one or more of the plurality of target objects when reeled in via the at least one cable.

Clause 7. The capture bag of Clause 5, wherein each of the flexible bags is configured to contain leaking liquids and/or fragments of the plurality of target objects.

Clause 8. The capture bag of Clause 1, further comprising: one or more nozzles configured to separately spray foam onto each of the plurality of target objects, the foam configured to separately stick to each of the plurality of target objects and expand to conform to shapes of the plurality of target objects.

Clause 9. The capture bag of Clause 1, further comprising: a plurality of deployment struts configured to expand to support the main bag; and an inflation system configured to inflate the plurality of deployment struts.

Clause 10. The capture bag of Clause 1, further comprising a trash compactor configured to separately compact each of the plurality of target objects.

Clause 11. The capture bag of Clause 1, wherein the main bag is formed of a material selected to act as a shield for electromagnetic radiation to prevent outside radiation or signals from reaching the target objects and/or to prevent radiation from the target objects from interfering with outside activities.

Clause 12. The capture bag of Clause 11, wherein the shield is configured to block one or more of the following fields: electrostatic, radio frequency and microwave, infrared, visible, and/or ultraviolet radiations.

Clause 13. The capture bag of Clause 11 wherein the main bag has an interior layer configured to absorb radiation emitted from the target objects.

Clause 14. The capture bag of Clause 1, wherein: the main bag comprises electrically conductive current loops have been incorporated into the main bag. the electrically conductive current loops are configured to generate a solenoidal magnetic field configured to act against external magnetic fields when supplied with electrical current to apply mechanical torques to a spacecraft coupled to the capture bag.

Clause 15. The capture bag of Clause 1, further comprising one or more flexible pressure-tight deployment tubes configured to be inflated to unfold the main bag from a stowed configuration.

Clause 16. The capture bag of Clause 15, wherein the main bag has a deployed shape determined by controlled inflation of the one or more flexible pressure-tight deployment tubes, the one or more flexible pressure-tight deployment tubes comprising a plurality ribs and a plurality of struts that are fixed to the capture bag and are attached to the main bag at several attachment points.

Clause 17. The capture bag of Clause 16, wherein the deployed shape of the capture bag is configured to be changed and/or adjusted to close and capture the target objects by selectively inflating the plurality ribs and the plurality of struts.

Clause 18. The capture bag of Clause 1, wherein the main bag is configured to be unfolded from a stowed configuration by releasing a plurality of pretensioned tape springs.

Clause 19. The capture bag of Clause 1, wherein the main bag and one or more flexible deployment tubes are configured to be z-folded to a stowed configuration.

Clause 20. The capture bag of Clause 19, wherein each of the flexible deployment tubes comprises an internal porous tube having a computer-controlled gas discharge port configured to vent trapped gasses into space before the capture bag is released for controlled inflation.

Clause 21. The capture bag of Clause 20, wherein the flexible deployment tubes are constructed from a gas-tight membrane that has been bonded to an internal fabric liner including loosely meshed fibers.

Clause 22. The capture bag of Clause 1, wherein the main bag includes a first main bag and a second main bag, the second main bag configured to be closed and sealed independently of the first main bag.

Clause 23. The capture bag of Clause 22, wherein: the second main bag is configured to capture, enclose, and hermetically seal a contaminated space object, and the first main bag is configured to enclose the second main bag to prevent contamination of an outer surface of the second main bag.

Clause 24. A method of capturing space debris, comprising: opening a main bag of a capture bag; capturing a first target through the opening of the main bag; sealing the main bag and containing the first target; opening the main bag; capturing a second target through the opening of the main bag; and sealing the main bag and containing the first target.

Clause 25. The method of Clause 24, wherein: containing the first target comprises containing the first target in a first flexible net; and containing the second target comprises containing the second target in a second flexible net, the first and second flexible nets arranged in layers within the main bag.

Clause 26. The method of Clause 25, further comprising: separately reeling in the first and second flexible nets using a motor and at least one cable such that the first and second flexible nets respectively contract onto the first and second targets.

Clause 27. The method of Clause 25, further comprising: separately reeling in the first and second flexible nets using an elastic cable such that the first and second flexible nets respectively contract onto the first and second targets.

Clause 28. The method of Clause 24, wherein: containing the first target comprises containing the first target in a first flexible bag; and containing the second target comprises containing the second target in a second flexible bag, the first and second flexible bag arranged in layers within the main bag.

Clause 29. The method of Clause 28, further comprising: separately reeling in the first and second flexible bags using at least one cable such that the first and second flexible bags respectively contract onto the first and second targets.

Clause 30. The method of Clause 28, wherein each of the flexible bags is configured to contain leaking liquids and/or fragments of the first and second targets.

Clause 31. The method of Clause 24, further comprising: separately spraying, using one or more nozzles, foam onto each of the first and second targets, the foam configured to separately stick to each of the first and second targets and expand to conform to shapes of the first and second targets.

Clause 32. The method of Clause 24, further comprising: expanding a plurality of deployment struts to support the main bag; and inflate the plurality of deployment struts using an inflation system.

Clause 33. The method of Clause 24, further comprising: separately compacting each of the first and second targets using a trash compactor.

Clause 34. A system for capture of space objects, the system comprising: a proximity engine configured to locate the system within an operable distance of space debris; and a deployable structure configured to at least partially enclose the space debris, the deployable structure comprising: a surrounding material configured to at least partially enclose the space debris, the material having sufficient flexibility and resilience to reduce rotational energy and resist ripping; and an extension device configured to move the surrounding material through the operable distance such that the surrounding material at least partially encloses and thereby captures the space debris.

Clause 35. The system of Clause 34, wherein the surrounding material comprises a mylar capture bag.

Clause 36. The system of Clause 34, wherein the surrounding material comprises at least one net.

Clause 37. The system of Clause 34, wherein the surrounding material comprises a foam material.

Clause 38. The system of Clause 34, wherein the surrounding material comprises an outer capture bag and at least two internal surrounding structures.

Clause 39. The system of Clause 38, wherein the at least two internal surrounding structures comprise at least one resilient net configured to retain debris as the outer capture bag is re-opened to capture additional debris.

Clause 40. The system of Clause 34, wherein the extension device comprises flexural inflatable struts configured to open the surrounding material.

Clause 41. The system of Clause 34, further comprising a robotic zipper configured to seal the surrounding material.

Clause 42. The system of Clause 38, further comprising a cable system configured to retract and retain the surrounding material and space debris.

Clause 43. The system of Clause 34, further comprising at least one proximity operation sensor.

Clause 44. The system of Clause 34, wherein the proximity engine comprises a robotic arm end-effector.

Clause 45. The system of Clause 34, further comprising stereo cameras positioned within the surrounding material.

Clause 46. The system of Clause 34, wherein the surrounding material comprises a first sacrificial material configured to slow rotation and a second material configured for long-term capture.

Clause 47. The system of Clause 34, wherein the surrounding material further comprising at least one mechanical rotation device configured to manage changes of angular momentum.

Clause 48. The system of clause 34, wherein the surrounding material comprises a main bag formed of a material selected to act as a shield for electromagnetic radiation to prevent outside radiation or signals from reaching the target objects and/or to prevent radiation from the target objects from interfering with outside activities.

Clause 49. The system of clause 48, wherein the shield is configured to block one or more of the following fields: electrostatic, radio frequency and microwave, infrared, visible, and/or ultraviolet radiations.

Clause 50. The system of clause 48, wherein the main bag has an interior layer configured to absorb radiation emitted from the target objects.

Clause 51. The system of clause 34, wherein the surrounding material comprises a main bag configured to at least partially enclose the space debris, the main bag including electrically conductive current loops incorporated therein and configured to generate a solenoidal magnetic field configured to act against external magnetic fields when supplied with electrical current to apply mechanical torques to a spacecraft coupled to the capture bag.

Clause 52. The system of clause 34, wherein the surrounding material comprises a main bag configured to at least partially enclose the space debris, and the extension device comprises one or more flexible pressure-tight deployment tubes configured to inflate and unfold the main bag from a stowed configuration.

Clause 53. The system of clause 52, the main bag having a deployed shape determined by controlled inflation of the one or more flexible pressure-tight deployment tubes, the one or more flexible pressure-tight deployment tubes comprising a plurality of ribs and a plurality of struts that are fixed to the capture bag and are attached to the main bag at several attachment points.

Clause 54. The system of clause 53, wherein the deployed shape of the capture bag is configured to be changed and/or adjusted to close and capture the target objects by selectively inflating the plurality ribs and/or struts.

Clause 55. The system of clause 34, wherein the surrounding material comprises a main bag configured to at least partially enclose the space debris and configured to be unfolded from a stowed configuration by releasing a plurality of extension devices comprising pretensioned tape springs.

Clause 56. The system of clause 34, wherein the surrounding material comprises a main bag configured to at least partially enclose the space debris and the main bag and one or more extension devices comprising flexible deployment tubes are configured to be z-folded to a stowed configuration.

Clause 57. The system of clause 56, wherein each of the flexible deployment tubes comprises an internal porous tube having a computer-controlled gas discharge port configured to vent trapped gasses into space before the capture bag is released for controlled inflation.

Clause 58. The system of clause 57, wherein the flexible deployment tubes are constructed from a gas-tight membrane that has been bonded to an internal fabric liner including loosely meshed fibers.

Clause 59. The system of clause 34, wherein the surrounding structure comprises a main bag configured to at least partially enclose the space debris, the main bag comprising a first sack and a second sack, the second sack configured to be closed and sealed independently of the first sack.

Clause 60. The system of clause 59, wherein: the second sack is configured to capture, enclose, and hermetically seal a contaminated space object, and the first sack is configured to enclose the second sack to prevent contamination of an outer surface of the second sack.

Clause 61. A method of reducing propellant for space debris capture missions comprising: identifying multiple debris targets for a round-trip path; approaching and capturing a first debris target in a first enclosure; and while the first debris target is still captured, approaching and capturing a second debris target in the first enclosure while retaining the first debris target in the first enclosure.

Clause 62. The method of Clause 61, further comprising retaining the first debris target in the first enclosure using a non-rigid retention material configured to surround the first debris target and a tether configured to link the non-rigid retention material to an interior side of the first enclosure.

Clause 63. A method of reducing propellant for space debris capture missions comprising: approaching a rotating debris target; and using a resilient capture enclosure to reduce rotation energy of the debris target, thereby reducing a need for precise maneuvering to more closely match rotation prior to debris capture.

Clause 64. The method of Clause 63, wherein the resilient capture enclosure comprises spray able foam material.

Clause 65. The method of Clause 63, wherein the resilient capture enclosure comprises tethered netting.

Clause 66. The method of Clause 63, wherein the resilient capture enclosure comprises a thin flexible film.

Clause 67. The method of Clause 63, wherein using a resilient capture enclosure to reduce rotation energy of the debris target comprises spraying a foam material to adhere to the rotating debris target, thereby slowing rotation and smoothing a surface of the debris target and reducing tear risk.

Clause 68. The method of Clause 63, further comprising reducing rotation energy of the debris target after capture using a maneuvering system.

### Conclusion

Not necessarily all objects or advantages may be achieved in accordance with any particular embodiment described herein. Certain embodiments may be configured to operate in a manner that achieves or optimizes one advantage or group of advantages as taught herein without necessarily achieving other objects or advantages as may be taught or suggested herein.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language used herein, such as, among others, “can,” “might,” “may,” “e.g.,” “for example,” and the like, unless specifically stated otherwise, or otherwise understood within the context as used, is generally intended to convey that certain embodiments include, while other embodiments do not include, certain features, elements, or states. Thus, such conditional language is not generally intended to imply that features, elements or states are in any way required for one or more embodiments.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Such disjunctive language is not generally intended to, and should not, imply that certain embodiments require at least one of X, at least one of Y, and at least one of Z to each be present. Thus, the term “or” is used in its inclusive sense (and not in its exclusive sense) so that when used, for example, to connect a list of elements, the term “or” means one, some, or all of the elements in the list.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The terms “comprising,” “including,” “having,” and the like are synonymous and are used inclusively, in an open-ended fashion, and do not exclude additional elements, features, acts, operations, and so forth.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others.

1. A capture bag for capturing space debris, comprising:
a main bag configured to open to allow a plurality of target objects to enter the main bag; and
a containment system configured to separately contain the plurality of target objects.

2. The capture bag of claim 1, wherein the containment system comprises:
a plurality of flexible nets arranged in layers within the main bag, wherein each of the flexible nets is configured to contain one or more of the plurality of target objects.

3. The capture bag of claim 2, further comprising:
at least one cable coupled to the flexible nets; and
a motor configured to separately reel in each of the flexible nets using the at least one cable, each of the flexible nets configured to contract onto the one or more of the plurality of target objects when reeled in via the at least one cable.

4. The capture bag of claim 2, further comprising:
at least one elastic cable coupled to the flexible nets, the at least one elastic cable configured to separately reel in each of the flexible nets, each of the flexible nets configured to contract onto the one or more of the plurality of target objects when reeled in via the at least one elastic cable.

5. The capture bag of claim 1, wherein the containment system comprises:
a plurality of flexible bags arranged in layers within the main bag, wherein each of the flexible bags is configured to contain one or more of the plurality of target objects.

6. The capture bag of claim 5, further comprising:
at least one cable coupled to the flexible bags; and
a motor configured to separately reel in each of the flexible bags using the at least one cable, each of the flexible bags configured to contract onto the one or more of the plurality of target objects when reeled in via the at least one cable.

7. The capture bag of claim 5, wherein each of the flexible bags is configured to contain leaking liquids and/or fragments of the plurality of target objects.

8. The capture bag of claim 1, further comprising:
one or more nozzles configured to separately spray foam onto each of the plurality of target objects, the foam configured to separately stick to each of the plurality of target objects and expand to conform to shapes of the plurality of target objects.

9. The capture bag of claim 1, further comprising:
a plurality of deployment struts configured to expand to support the main bag; and
an inflation system configured to inflate the plurality of deployment struts.

10. The capture bag of claim 1, further comprising a trash compactor configured to separately compact each of the plurality of target objects.

11. The capture bag of claim 1, wherein the main bag is formed of a material selected to act as a shield for electromagnetic radiation to prevent outside radiation or signals from reaching the target objects and/or to prevent radiation from the target objects from interfering with outside activities.

12. The capture bag of claim 11, wherein the shield is configured to block one or more of the following fields: electrostatic, radio frequency and microwave, infrared, visible, and/or ultraviolet radiations.

13. The capture bag of claim 11 wherein the main bag has an interior layer configured to absorb radiation emitted from the target objects.

14. The capture bag of claim 1, wherein:
the main bag comprises electrically conductive current loops have been incorporated into the main bag,
the electrically conductive current loops are configured to generate a solenoidal magnetic field configured to act against external magnetic fields when supplied with electrical current to apply mechanical torques to a spacecraft coupled to the capture bag.

15. The capture bag of claim 1, further comprising one or more flexible pressure-tight deployment tubes configured to be inflated to unfold the main bag from a stowed configuration.

16. The capture bag of claim 15, wherein the main bag has a deployed shape determined by controlled inflation of the one or more flexible pressure-tight deployment tubes, the one or more flexible pressure-tight deployment tubes comprising a plurality ribs and a plurality of struts that are fixed to the capture bag and are attached to the main bag at several attachment points.

17. The capture bag of claim 16, wherein the deployed shape of the capture bag is configured to be changed and/or adjusted to close and capture the target objects by selectively inflating the plurality ribs and the plurality of struts.

18. The capture bag of claim 1, wherein the main bag is configured to be unfolded from a stowed configuration by releasing a plurality of pretensioned tape springs.

19. The capture bag of claim 1, wherein the main bag and one or more flexible deployment tubes are configured to be z-folded to a stowed configuration.

20. The capture bag of claim 19, wherein each of the flexible deployment tubes comprises an internal porous tube having a computer-controlled gas discharge port configured to vent trapped gasses into space before the capture bag is released for controlled inflation.

21. The capture bag of claim 20, wherein the flexible deployment tubes are constructed from a gas-tight membrane that has been bonded to an internal fabric liner including loosely meshed fibers.

22. The capture bag of claim 1, wherein the main bag includes a first main bag and a second main bag, the second main bag configured to be closed and sealed independently of the first main bag.

23. The capture bag of claim 22, wherein:
the second main bag is configured to capture, enclose, and hermetically seal a contaminated space object, and
the first main bag is configured to enclose the second main bag to prevent contamination of an outer surface of the second main bag.

24-68. (canceled)
